(19) United States
(12) Patent Application Publication
(10) Pub. No.: US 2021/0387573 A1
(43) Pub. Date: Dec. 16, 2021

(54) METHODS AND APPARATUS TO ADJUST A REACTIVE SYSTEM BASED ON A SENSORY INPUT AND VEHICLES INCORPORATING SAME

(71) Applicant: Indigo Technologies, Inc., Woburn, MA (US)

(72) Inventors: Peter HINSON, Oakland, CA (US); Adam Wahab, Cambridge, MA (US); Grant W. Kristofek, Wayland, MA (US); Ian W. HUNTER, Lincoln, MA (US)

(21) Appl. No.: 17/284,285

(22) PCT Filed: Oct. 11, 2019
(86) PCT No.: PCT/US19/55814

§ 371 Date: Apr. 9, 2021

Related U.S. Application Data
(63) Continuation-in-part of application No. PCT/US2019/029793, filed on Apr. 30, 2019.
(60) Provisional application No. 62/679,458, filed on Jun. 1, 2018.
(60) Provisional application No. 62/664,656, filed on Apr. 30, 2018.
(60) Provisional application No. 62/745,038, filed on Oct. 12, 2018.

(51) Int. Cl. B60R 1/00; G06T 7/70; G06T 7/593; G06T 3/40; B60W 30/02; B60W 40/08; B60W 50/14; B60J 3/00

(52) U.S. Cl. CPC B60R 1/00; B60W 2510/0225; G06T 7/593; G06T 3/4084; B60W 30/02; B60W 40/08; B60W 50/14; B60J 3/00; B60R 2300/306; B60R 2300/50; B60R 2300/605; G06T 2207/10016; G06T 2207/30252; G06T 2207/10048; B60W 2510/18; B60W 2540/225; B60W 2050/146; B60W 2420/42; G06T 7/70

(57) ABSTRACT

A conventional vehicle typically behaves like a single rigid body with fixed characteristics defined during the design phase of the vehicle. The rigid nature of the conventional vehicle limits their ability to adjust to different operating conditions, thus limiting usability and performance. To overcome these limitations, a reactive vehicle may be used that includes a sensor and a reactive system. The sensor may monitor the position and/or orientation of an operator, the vehicle operating conditions, and/or the environment conditions around the vehicle. The reactive system may adjust some aspect of the vehicle based on the data acquired by the sensor. For example, the reactive system may include a video-based mirror with a field of view that changes based on the operator's movement. In another example, the reactive system may include an articulated joint that changes the physical configuration the vehicle based on the operator's movement.

### CROSS-REFERENCE TO RELATED PATENT APPLICATION(S)

This application is a continuation-in-part (CIP) of International Application No. PCT/US2019/029793, filed on Apr. 30, 2019, and entitled, “ARTICULATED VEHICLES WITH PAYLOAD-POSITIONING SYSTEMS,” which in turn claims priority to U.S. Application No. 62/664,656, filed Apr. 30, 2018, and entitled “ARTICULATED VEHICLE.” This application also claims priority to U.S. Application No. 62/745,038, filed on Oct. 12, 2018, and entitled “APPARATUS FOR A REACTIVE CAMERA MONITORING SYSTEM AND METHODS FOR THE SAME.” Each of these applications is incorporated herein by reference in its entirety.

### BACKGROUND

A human-operated vehicle (e.g., an automobile) is typically controlled by a driver located in a cabin of the vehicle. In order to operate the vehicle safely, the driver should preferably be aware of objects (e.g., a person, a road barrier, another vehicle) near the vehicle. However, the driver's field of view (FOV) of the surrounding environment is limited primarily to a region in front of the driver's eyes due, in part, to the limited peripheral vision of the human eye. The driver should thus move their eyes and/or their head to shift their FOV in order to check the surroundings of the vehicle (e.g., checking blind spots when changing lanes), usually at the expense of shifting the driver's FOV away from the vehicle's direction of travel. The driver's FOV may be further limited by obstructions within the vehicle cabin, such as the cabin's structure (e.g., the door panels, the size of the windows, the A, B, or C pillars) or objects in the cabin (e.g., another passenger, large cargo).

Conventional vehicles typically include mirrors to expand the driver's FOV. However, the increase to the driver's FOV is limited. For example, traditional automotive mirrors typically provide a medium FOV to reduce distance distortion and to focus the driver's attention on certain areas around the vehicle. At a normal viewing distance, the horizontal FOV of mirrors used in automobiles is typically in the range of 10-15°, 23-28°, and 20-25° for the driver side, center (interior), and passenger side mirrors, respectively. Furthermore, a conventional vehicle is predominantly a single rigid body during operation. Thus, the FOV of the cabin is determined primarily during the design phase of the vehicle and is thus not readily reconfigurable after production without expensive and/or time consuming modifications.

### SUMMARY

Embodiments described herein are directed to a vehicle that includes a reactive system that responds, in part, to a change in the position and/or orientation of an operator (also referred to as a “driver”). (A vehicle with a reactive system may be called a reactive vehicle.) For example, the reactive system may adjust a FOV of the operator as the operator moves their head. This may be accomplished in several ways, such as by physically actuating an articulated joint of the vehicle in order to change the position of the operator with respect to the environment or by adjusting video imagery displayed to the operator of a region outside the vehicle. In this manner, the reactive system may extend the operator's FOV, thus providing the operator greater situational awareness of the vehicle's surroundings while enabling the operator to maintain awareness along the vehicle's direction of travel. The reactive system may also enable the operator to see around and/or over objects by adjusting a position of a camera on the vehicle or the vehicle itself, which is not possible with conventional vehicles.

In one aspect, the position and/or orientation of the driver may be measured by one or more sensors coupled to the vehicle. The sensors may be configured to capture various types of data associated with the operator. For example, the sensor may include a camera to acquire red, green, blue (RGB) imagery of the operator and a depth map sensor to acquire a depth map of the operator. The RGB imagery and the depth map may be used to determine coordinates of various facial and/or pose features associated with the operator, such as an ocular reference point of the driver's head. The coordinates of the various features of the operator may be measured as a function of time and used as input to actuate the reactive system.

The use of various data types to determine the features of the operator may reduce the occurrence of false positives (i.e., detecting spurious features) and enable feature detection under various lighting conditions. The detection of these features may be accomplished using several methods, such as a convolutional neural network. A motion filtering system (e.g., a Kalman filter) may also be used to ensure the measured features of the operator change smoothly as a function of time by reducing, for example, unwanted jitter in the RGB imagery of the operator. The depth map may also be used with the RGB image in several ways. For example, the depth may mask the RGB image such that a smaller portion of the RGB image is used for feature detection thereby reducing the computational cost.

The one or more sensors may also measure various environmental conditions, such as the type of road surface, the vehicle speed and acceleration, obstacles near the vehicle, and/or the presence of precipitation. The measured environmental conditions may also be used as inputs to the reactive system. For example, the environmental conditions may modify the magnitude of a response of the reactive system (e.g., adjustment to ride height) based on the speed of the vehicle (e.g., highway driving vs. city driving). In some cases, the environmental conditions may also be used as a gate where certain conditions (e.g., vehicle speed, turn rate, wheel traction), if met, may prohibit activation of the reactive system in order to maintain safety of the operator and the vehicle.

The reactive system may include a video-based mirror assembled using a camera and a display. The camera may be coupled to the vehicle and oriented to acquire video imagery of a region outside the vehicle (e.g., the rear of the vehicle). The display may be used to show the video imagery of the region to the operator. As the driver moves, the video imagery shown on the display may be transformed in order to adjust the FOV of the region captured by the camera. For instance, the operator may rotate their head and the video imagery correspondingly shifted (e.g., by panning the camera or shifting the portion of the video imagery being shown on the display) to emulate a response similar to a conventional mirror. The reactive system may include multiple cameras such that the aggregate FOV of the cameras substantially covers the vehicle surroundings, thus reducing or, in some instances, eliminating the operator's blind spots when operating the vehicle. The video imagery acquired by the multiple cameras may be displayed on one or more displays.

The reactive system may include an articulated joint to physically change a configuration of the vehicle. The articulated joint may include one or more mechanisms, such as an active suspension of a vehicle to adjust the tilt/ride height of the vehicle and/or a hinge that causes the body of the vehicle to change shape (e.g., rotating a front section of the vehicle with respect to a tail section of the vehicle). In one example, the articulated joint may include a guide structure that defines a path where a first portion of the vehicle is movable relative to a second portion along the path, a drive actuator to move the first portion of the vehicle along the path, and a brake to hold the first portion of the vehicle at a particular position along the path.

The articulated joint may be used to modify the position of the operator with respect to the environment. For example, the reactive system may use the articulated joint to tilt the vehicle when the operator tilts their head to look around an object (e.g., another vehicle). In another example, the reactive system may increase the ride height of the vehicle when the operator pitches their head upwards in order to look over an object (e.g., a barrier). In such cases, the reactive system may be configured to actuate the articulated joint in a manner that doesn't compromise vehicle stability. For instance, the reactive system may reduce the magnitude of the actuation or, in some instances, prevent the articulated joint from actuating when the vehicle is traveling at high speeds. The reactive system may also actuate the articulated joint in conjunction with explicit operator commands (e.g., commands received from input devices, such as a steering wheel, an accelerator, a brake).

Another method of operating a (reactive) vehicle includes receiving a first input from an operator of the vehicle using a first sensor and receiving a second input from an environment outside the vehicle using a second sensor. A processor identifies a correlation between the first and second inputs and generating a behavior-based command based on the correlation. This behavior-based command causes the vehicle to move with a pre-defined behavior when applied to an actuator of the vehicle. The processor generates a combined command based on the behavior-based command, an explicit command from the operator via an input device operably coupled to the processor, and the second input. It adjusts and/or filters the combined command to maintain stability of the vehicle, then actuates the actuator of the vehicle using the adjusted and/or filtered combined command.

Although the above examples of a reactive system are described in the context of modifying a FOV of an operator and/or a camera, the reactive system and the various components therein may also be used for other applications. For example, the reactive system may be used as a security system for the vehicle. The reactive system may recognize and allow access to the vehicle for approved individuals while impeding access for other individuals (e.g., by actuating the vehicle in order to prevent entry). In another example, the reactive system may cause the vehicle to via an articulated joint, emit a sound (e.g., honking), and/or to turn on/flash its headlights such that the operator is able to readily locate the vehicle (e.g., in a parking lot containing a plurality of vehicles). In another example, the vehicle may have an autonomous mode of operation where the reactive system is configured to command the vehicle to follow an operator located outside the vehicle. This may be used, for example, to record video imagery of the operator as the operator moves within an environment. In another example, the reactive system may adjust the position of the operator (e.g., via an articulated joint) in order to reduce glare on the operator's ocular region.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows an articulated vehicle that articulates to shift the driver's field of view in response to a headlight beam from an oncoming vehicle.

FIG. 2 shows a coordinate system with an origin centered on the driver's head.

FIG. 3 shows a seat with calibration features for a reactive vehicle system.

FIG. 4 shows an exemplary reactive mirror in a vehicle.

FIG. 5A shows the various components of the reactive mirror of FIG. 4 disposed in and on a conventional vehicle and the field of view (FOV) of each camera.

FIG. 5B shows the various components of the reactive mirror of FIG. 4 disposed in and on an articulated vehicle and the FOV of each camera.

FIG. 6 illustrates a method for acquiring and transforming video imagery acquired by the cameras of the reactive mirror of FIG. 4 based on the position and/or orientation of an operator.

FIG. 7A shows a side, cross-sectional view of an exemplary vehicle with an articulated joint.

FIG. 7B shows a side view of the vehicle of FIG. 7A.

FIG. 7C shows a top view of the vehicle of FIG. 7B.

FIG. 7D shows a side view of the vehicle of FIG. 7B in a low profile configuration where the outer shell of the tail section is removed.

FIG. 7E shows a side view of the vehicle of FIG. 7B in a high profile configuration where the outer shell of the tail section is removed.

FIG. 8A shows a perspective view of an exemplary articulated joint in a vehicle.

FIG. 8B shows a side view of the articulated joint of FIG. 8A.

FIG. 8C shows a top, side perspective view of the articulated joint of FIG. 8A.

FIG. 8D shows a bottom, side perspective view of the articulated joint of FIG. 8A.

FIG. 8E shows a top, side perspective view of the carriage and the track system in the guide structure of FIG. 8A.

FIG. 8F shows a top, side perspective view of the track system of FIG. 8E.

FIG. 8G shows a cross-sectional view of a bearing in a rail in the track system of FIG. 8F.

FIG. 9 shows a flow diagram of a method for operating a reactive system of a vehicle.

FIG. 10A shows various input parameters associated with an operator controlling a vehicle and exemplary ranges of the input parameters when the vehicle is turning.

FIG. 10B shows various input parameters associated with an environment surrounding the vehicle and exemplary ranges of the input parameters when the vehicle is turning.

FIG. 11A shows a displacement of an articulated vehicle along an articulation axis as a function of a driver position where the limit to the displacement is adjusted to maintain stability.

FIG. 11B shows a displacement of an articulated vehicle along an articulation axis as a function of a driver position where the rate of change of the displacement is adjusted to maintain stability.

FIG. 12A shows an articulated vehicle equipped with a sensor to monitor the position of a second vehicle using video imagery and a depth map acquired by the sensor.

FIG. 12B shows the articulated vehicle of FIG. 12A being tilted, which changes the position of the second vehicle measured with respect to the sensor on the articulated vehicle.

FIG. 13 shows an articulated vehicle whose ride height is adjusted to increase the FOV of an operator and/or a sensor.

FIG. 14A shows an articulated vehicle with a limited FOV due to the presence of a second vehicle.

FIG. 14B shows the articulated vehicle of FIG. 14A tilted to see around the second vehicle.

FIG. 15A shows a top view of an articulated vehicle and the FOV of the articulated vehicle.

FIG. 15B shows a front view of the articulated vehicle and the FOV of the articulated vehicle of FIG. 15A.

FIG. 15C shows a side view of the articulated vehicle of FIG. 15A traversing a series of steps.

FIG. 16 shows an articulated vehicle that identifies a person approach the vehicle and, if appropriate, reacts to prevent the person from accessing the articulated vehicle.

FIG. 17 shows an articulated vehicle that acquires video imagery of an operator located outside the articulated vehicle.

### DETAILED DESCRIPTION

Following below are more detailed descriptions of various concepts related to, and implementations of, a reactive vehicle system, a reactive mirror system, an articulated vehicle, and methods for using the foregoing. The concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

The discussion below describes various examples of a vehicle, a reactive system, a reactive mirror, and an articulated mechanism. One or more features discussed in connection with a given example may be employed in other examples according to the present disclosure, such that the various features disclosed herein may be readily combined in a given system according to the present disclosure (provided that respective features are not mutually inconsistent).

A Vehicle with a Sensor and a Reactive System

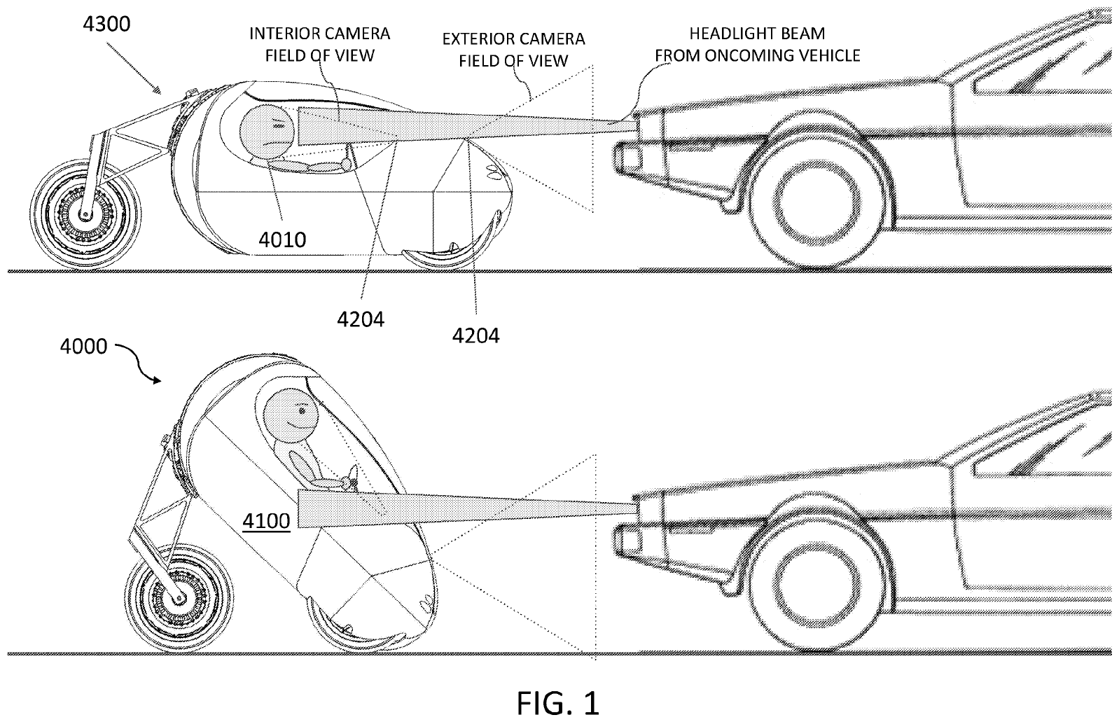

FIG. 1 shows an (articulated) vehicle 4000 with a body 4100. One or more sensors, including an external camera 4202 and an internal camera 4204, may be mounted to the body 4100 to measure various inputs associated with the vehicle 4000 including, but not limited to a pose and/or an orientation of an operator (e.g., a driver 4010), operating parameters of the vehicle 4000 (e.g., speed, acceleration, wheel traction), and environmental conditions (e.g., ambient lighting). A reactive system (illustrated in FIG. 1 as an articulated joint 4300) may be coupled to the vehicle 4000 to modify some aspect of the vehicle 4000 (e.g., changing a FOV of the operator 4010, traversing variable terrain, etc.) based, in part, on the inputs measured by the sensors 4202 and 4204. In FIG. 1, for example, the reactive system 4300 articulates the vehicle to move the user's head out of the path of on an oncoming vehicle's headlight beam(s) as detected by the external camera 4204. The vehicle 4000 may also include a processor (not shown) to manage the sensors 4202 and 4204 and the reactive system 4300 as well as the transfer of data and/or commands between various components in the vehicle 4000 and its respective subsystems.

The reactive system 4300 may include or be coupled to one or more sensors to acquire various types of data associated with the vehicle 4000. For example, the interior camera 4204 may acquire both depth and red-green-blue (RGB) data of the cabin of the vehicle 4000 and/or the operator 4010. Each pixel of a depth frame may represent the distance between an object subtending the pixel and het capture source of the depth map sensor. The depth frame may be acquired using structured infrared (IR) projections and two cameras in a stereo configuration (or similar depth capture). The depth frames are used to generate a depth map representation of the operator 4010 and the vehicle cabin. RGB frames may be acquired using a standard visible light camera. Other types of data acquired by the sensor 4200 may include, but is not limited to the operator's heart rate, gait, and facial recognition of the operator 4010.

The external camera 4202 and/or other sensors, including inertial measurement units or gyroscopes, may be configured to acquire various vehicle parameters and/or environmental conditions including, but not limited to the orientation of the vehicle 4000, the speed of the vehicle 4000, the suspension travel, the acceleration rate, the topology of the road surface, precipitation, day/night sensing, road surface type (e.g., paved smooth, paved rough, gravel, dirt), other objects/obstructions near the vehicle 4000 (e.g., another car, a person, a barrier). The operational frequency of these sensors may be at least 60 Hz and preferably 120 Hz.

Various operating parameters associated with each sensor may be stored including, but not limited to intrinsic parameters related to the sensor (e.g., resolution, dimensions) and extrinsic parameters (e.g., the position and/or orientation of the internal camera 4204 within the coordinate space of the vehicle 4000). Each sensor's operating parameters may be used to convert between a local coordinate system associated with that sensor and the vehicle coordinate system. For reference, the coordinate system used herein may be a right-handed coordinate system based on International Organization for Standards (ISO) 16505-2015. In this coordinate system, the positive x-axis is pointed along the direction opposite to the direction of forward movement of the vehicle 4000, the z-axis is orthogonal to the ground plane and points upwards, and the y-axis points to the right when viewing the forward movement direction.

The processor (also referred to herein as a “microcontroller”) may be used to perform various functions including, but not limited to processing input data acquired by the sensor(s) (e.g., filtering out noise, combining data from various sensors), calculating transformations and/or generating commands to modify the reactive system 4300, and communicatively coupling the various subsystems of the vehicle 4000 (e.g., the external camera 4204 to the reactive system 4300). For example, the processor may be used to determine the position and/or orientation of the operator 4010 and generate an image transformation that is applied to video imagery. The processor may generally constitute one or more processors that are communicatively coupled together. In some cases, the processor may be a field programmable gate array (FPGA).

As described above, the internal camera 4202 may detect the position and/or orientation of the operator 4010 (e.g., the operator's head or body) in vehicle coordinate space. In the following example, the internal camera 4202 acquires both depth and RGB data of the operator 4010. Prior to feature detection, the processor may first align the RGB imagery and depth frames acquired by the internal camera 4202 such that corresponding color or depth data may be accessed using the pixel coordinates of either frame of RGB and depth data. The processing of depth maps typically uses fewer computational resources compared to the processing of an RGB frame. In some cases, the depth map may be used to limit and/or mask an area of the RGB frame for processing. For example, the depth map may be used to extract a portion of the RGB frame corresponding to a depth range of about 0.1 m to about 1.5 m for feature detection. Reducing the RGB frame in this manner may substantially reduce the computational power used to process the RGB frame as well as reducing the occurrence of false positives.

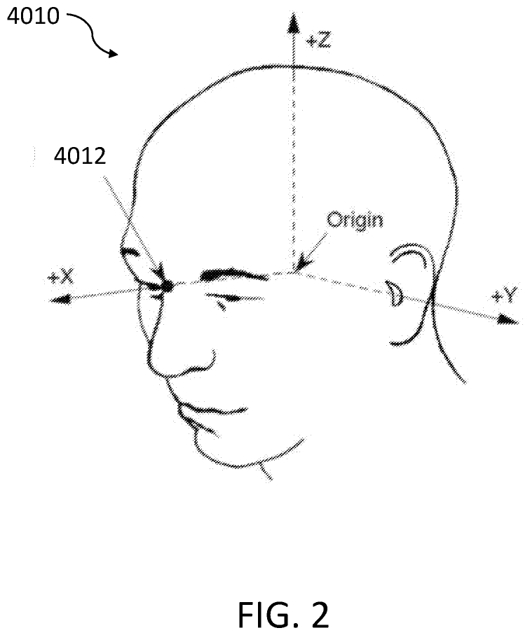

Feature detection may be accomplished in several ways. For example, pre-trained machine learning models (e.g., convolutional neural networks) may utilize depth, RGB, and/or a combination (RGBD) data to detect features of the operator 4010. The output of the model may include pixel regions corresponding to the body, the head, and/or facial features. The model may also provide estimates of the operator's pose. In some cases, once the processor 4400 identifies the operator's head, the processor 4400 may then estimate an ocular reference point of the operator 4010 (e.g., a middle point between the operator's eyes as shown in FIG. 2). The ocular reference point may then be de-projected and translated into coordinates within the vehicle reference frame. As described, feature detection may be a software construct, thus the models used for feature detection may be updated after the time of manufacture to incorporate advances in computer vision and/or to improve performance.

The sensors (e.g., the internal camera 4202) and the reactive system 4300 may also be calibrated to the operator 4010. Generally, the operator's height and location within the cabin of the vehicle 4000 (e.g., a different driving position) may vary over time. Variations in the operator's position and orientation may prevent the reactive system 4300 from being able to properly adjust the vehicle 4000 to aid the operator 4010 if the vehicle 4000 is not calibrated specifically to the operator 4010. The operator 4010 may activate a calibration mode using various inputs in the vehicle 4000 including, but not limited to pushing a physical button, selecting a calibration option on the control console of the vehicle 4000 (e.g., the infotainment system), and/or using a voice command.

Generally, calibrations may be divided into groups relating to (1) the operator's physical position and movement and (2) the operator's personal preferences. Calibrations related to the operator's physical position and movement may include establishing the operator's default sitting position and the operator's normal ocular point while operating the vehicle 4000 in vehicle coordinates within the vehicle 4000 and the operator's range of motion, which in turn affects the response range of the reactive system 4300 to changes in the position of the operator's head. The sensor 4200 may be used to acquire the operator's physical position and movement and the resultant ocular reference point may be stored for later use when actuating the reactive system 4300.

During calibration, the operator 4010 may be instructed to move their body in a particular manner. For example, audio or visual prompts from the vehicle's speakers and display may prompt the operator 4010 to sit normally, move to the right, or move to the left. The processor records the ocular reference point at each position to establish the default position and the range of motion. The prompts may be delivered to the operator 4010 in several ways, including, but not limited to visual cues and/or instructions shown on the vehicle's infotainment system and audio instructions through the vehicle's speakers. The processor may record the ocular reference point in terms of the coordinate system of the vehicle 4000 so that the ocular reference point can be used as an input for the various components in the reactive system 4300.

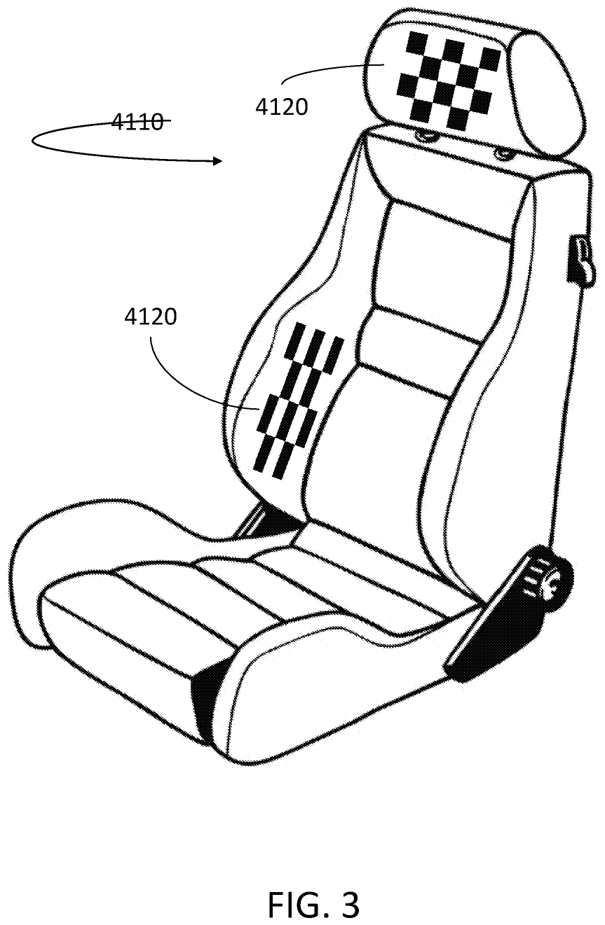

The internal camera 4202 may also be calibrated to a seat in the vehicle 4000, which may provide a more standardized reference to locate the internal camera 4202 (and the driver 4010) within the vehicle 4000. FIG. 3 shows a seat 4110 that includes calibration patterns 4120 to be detected by the sensor 4200. The shape and design of the calibration patterns 4120 may be known beforehand. They may be printed in visible ink or in invisible ink (e.g., ink visible only at near-infrared wavelengths). Alternatively, or in addition, the seat 4110 may have a distinctive shape or features (e.g., asymmetric features) that can be used as fiducial markers for calibration. By imaging the calibration pattern 4120 (and the seat 4110), the relative distance and/or orientation of the sensor 4200 with respect the seat may be found. In some cases, the calibration patterns 4120 may be formed at visible wavelengths (e.g., directly observable with the human eye) or infrared wavelengths (e.g., invisible to the human eye and detectable using only infrared imaging sensors).

Calibrations related to the operator's personal preferences may vary based on the type of reactive system 4300 being used. For example, the reactive system 4300 may utilize a video-based mirror that allows the operator 4010 to manually adjust video imagery shown in a manner similar to adjusting previous side-view mirrors. In another example, the reactive system 4300 may include an articulated joint. The operator 4010 may be able to tailor the magnitude and/or rate of actuation of the articulated joint (e.g., a gentler actuation may provide greater comfort, a more rapid, aggressive actuation may provide greater performance).

A Reactive System with a Video-Based Mirror

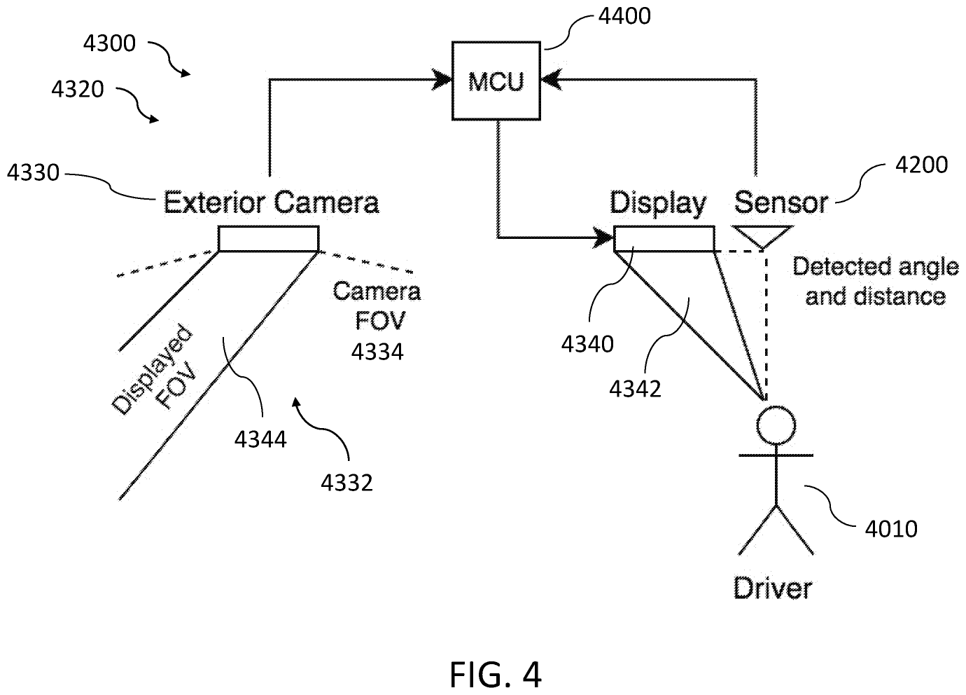

FIG. 4 shows an exemplary reactive system 4300 that includes a video-based mirror 4320. As shown, the mirror 4320 may include a camera 4330 coupled to the processor 4400 (also referred to as a microcontroller unit (MCU) 4400) to acquire source video imagery 4332 (also referred to as the “source video stream”) of a region of the environment 4500 outside the vehicle 4000. The mirror 4320 may also include a display 4340 coupled to the MCU 4400 to show transformed video imagery 4342 (e.g., a portion of the source video imagery 4332) to the operator 4010. The processor 4400 may apply a transformation to the source video imagery 4332 to adjust the transformed video imagery 4342 (e.g., a FOV and/or an angle of view) shown to the operator 4010 in response to the sensor 4200 detecting movement of the operator 4010. In this manner, the video-based mirror 4320 may supplement or replace conventional mirrors (e.g., a side-view, a rear-view mirror) in the vehicle 4000. For example, the video-based mirror 4320 may be used to reduce aerodynamic drag typically encountered when using conventional mirrors. In some cases, the mirror 4320 may be classified as a Camera Monitoring System (CMS) as defined by ISO 16505-2015.

The mirror 4320 may acquire source video imagery 4332 that covers a sufficient portion of the vehicle surroundings to enable safe operation of the vehicle 4000. Additionally, the mirror 4320 may reduce or mitigate scale and/or geometric distortion of the transformed video imagery 4342 shown on the display 4340. The mirror 4320 may also be configured to comply with local regulations. Conventional driver side and center mirrors are generally unable to exhibit these desired properties. For example, side view and center mirrors should provide unit magnification in the United States, which means the angular height and width of objects displayed should match the angular height and width of the same object as viewed directly at the same distance (Federal Motor Vehicle Safety Standards No. 111).

The camera 4330 may be used individually or as part of an array of cameras 4330 that each cover a respective region of the environment 4500 outside the vehicle 4000. The camera 4330 may include a lens (not shown) and a sensor (not shown) to acquire the source video imagery 4332 that, in combination, defines a FOV 4334 of the camera 4330.

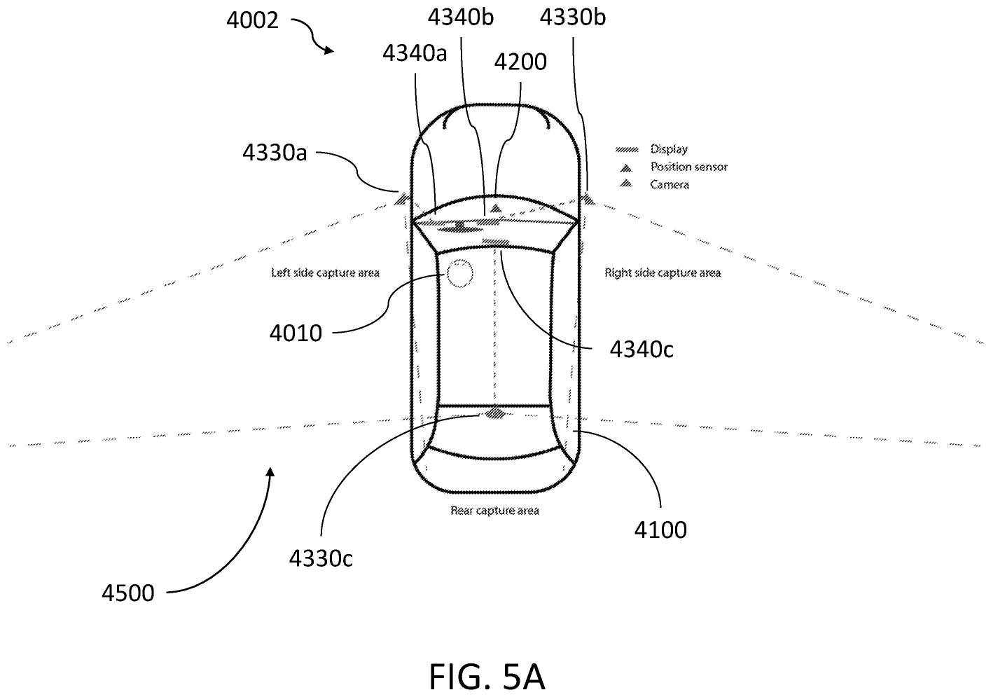

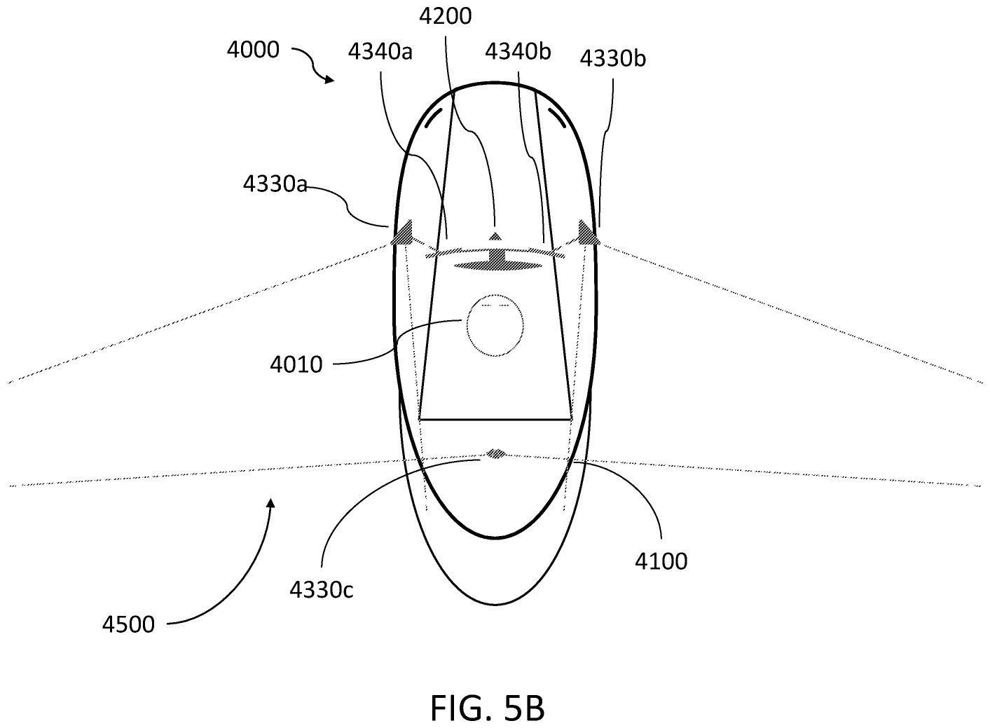

FIGS. 5A and 5B shows an articulated vehicle 4000 and a conventional vehicle 4002 that each includes camera 4330a, 4330b, and 4330c (collectively, cameras 4330) to cover left side, right side, and rear regions outside the vehicle 4000, respectively. Each vehicle 4000, 4002 also includes corresponding displays 4340a and 4340b showing transformed video imagery 4342 acquired by the cameras 4330a, 4330b, and 4330c. (The conventional vehicle may also include an additional display 4340c in place of a rearview mirror.) As shown, the cameras 4330 may be oriented to have a partially overlapping FOV 4334 such that no blind spots are formed between the different cameras 4330.

The placement of the cameras 4330 on the vehicle 4000 may depend on several factors. For example, the cameras 4330 may be placed on the body 4100 to capture a desired FOV 4334 of the environment 4500 (as shown in FIGS. 5A and 5B). The cameras 4330 may also be positioned to reduce aerodynamic drag on the vehicle 4000. For example, each camera 4330 may be mounted within a recessed opening on the door and/or side panel of the body 4100 or the rearward-facing portion of trunk of the vehicle 4000. The placement of the cameras 4330 may also depend, in part, on local regulations and/or guidelines based on the location in which the vehicle 4000 is being used (e.g., ISO 16505).

The FOVs 4334 of the cameras 4330 may be sufficiently large to support one or more desired image transformations applied to the source video imagery 4332 by the processor 4400. For example, the transformed video imagery 4342 shown on the display 4340 may correspond to a portion of the source video imagery 4332 acquired by the camera 4330 and thus have a FOV 4344 smaller than the FOV 4334. The sensor of the camera 4330 may acquire the source video imagery 4332 at a sufficiently high resolution such that the transformed video imagery 4342 at least meets the lowest resolution of the display 4340 across the range of supported image transformations.

The size of the FOV 4334 may be based, in part, on the optics used in the camera 4330. For example, the camera 4330 may use a wide-angle lens in order to increase the FOV 4334, thus covering a larger region of the environment 4500. The FOV 4334 of the camera 4330 may also be adjusted via a motorized mount that couples the camera 4330 to the body 4100 of the vehicle 4000. The motorized mount may rotate and/or pan the camera 4330, thus shifting the FOV 4334 of the camera 4330. This may be used, for instance, when the camera 4330 includes a lens with a longer focal length. The motorized mount may be configured to actuate the camera 4330 at a frequency that enables a desired responsiveness to the video imagery 4342 shown to the operator 4010. For example, the motorized mount may actuate the camera 4330 at about 60 Hz. In cases where the motorized mount actuates the camera 4330 at lower frequencies (e.g., 15 Hz), the processor 4400 may generate additional frames (e.g., via interpolation) in order to up-sample the video imagery 4342 shown on the display 4340.

Each camera 4330 may acquire the source video imagery 4332 at a variable frame rate depending on the lighting conditions and the desired exposure settings. For instance, the camera 4330 may nominally acquire the source video imagery 4332 at a frame rate of at least about 30 frames per second (FPS) and preferably 60 FPS. However, in low light situations, the camera 4330 may acquire source video imagery 4332 at a lower frame rate at least about 15 FPS.

Each camera 4330 may also be configured to acquire source video imagery 4332 at various wavelength ranges including, but not limited to visible, near-infrared (NIR), mid-infrared (MIR), and far-infrared (FIR) ranges. In some applications, an array of cameras 4330 disposed on the vehicle 4000 may be used to cover one or more wavelength ranges (e.g., one camera 4330 acquires visible video imagery and another camera 4330 acquires NIR video imagery) in order to enable multiple modalities when operating the mirror 4320. For example, the processor 4400 may show only IR video imagery on the display 4340 when the sensor 4200 detects the vehicle 4000 is operating in low visibility conditions (e.g., nighttime driving, fog).

The reactive system 4300 may store various operating parameters associated with each camera 4330 including, but not limited to intrinsic parameters related to the properties of the optics and/or the sensor (e.g., focal length, aspect ratio, sensor size), extrinsic parameters (e.g., the position and/or orientation of the camera 4330 within the coordinate space of the vehicle 4000), and distortion coefficients (e.g., radial lens distortion, tangential lens distortion). The operating parameters of the camera 4330 may be used to modify the transformations applied to the source video imagery 4332.

The display 4340 may be a device configured to show the transformed video imagery 4342 corresponding to the FOV 4344. As shown in FIGS. 5A and 5B, the vehicle 4000 may include one or more displays 4340. The display 4340 may generally show the video imagery 4332 acquired by one or more cameras 4330. For example, the display 4340 may be configured to show the transformed video imagery 4342 of multiple cameras 4330 in a split-screen arrangement (e.g., two transformed video imagery 4342 displayed side-by-side). In another example, the processor 4400 may transform the source video imagery 4332 acquired by multiple cameras 4330 such that the transformed video imagery 4342 shown on the display 4340 transitions seamlessly from one camera 4330 to another camera 4330 (e.g., the source video imagery 4332 are stitched together seamlessly). The vehicle may also multiple displays 4340 that each correspond to a camera 4330 on the vehicle 4000.

The placement of the display 4340 may depend on several factors. For example, the position and/or orientation of the display 4340 may be based, in part, on the nominal position of the operator 4010 or the driver's seat of the vehicle of the vehicle 4000. For example, one display 4340 may be positioned to the left of a steering wheel and another display 4340 positioned to the right of the steering wheel. The pair of displays 4340 may be used to show transformed video imagery 4342 from respective cameras 4330 located on the left and right sides of the vehicle 4000. The displays 4340 may be placed in a manner that allows the operator 4010 to see the transformed video imagery 4342 without having to lose sight of the vehicle's surroundings along the direction of travel. Additionally, the location of the display 4340 may also depend on local regulations and/or guidelines based on the location in which the vehicle 4000 is being used similar to the camera 4330.

In some cases, the display 4340 may also be touch sensitive in order to provide the operator 4010 the ability to input explicit commands to control the video-based mirror 4320. For example, the operator 4010 may touch the display 4340 with their hand and apply a swiping motion in order to pan and/or scale the portion of the transformed video imagery 4342 shown on the display 4340. When calibrating the video-based mirror 4320, the offset of the display 4340, which will be discussed in more detail below, may be adjusted via the touch interface. Additionally, the operator 4010 may use the touch interface to adjust various settings of the display 4340 including, but not limited to the brightness and contrast.

The reactive system 4300 may store various operating parameters associated with each display 4340 including, but not limited to intrinsic properties of the display 4340 (e.g., the display resolution, refresh rate, touch sensitivity, display dimensions), extrinsic properties (e.g., the position and/or orientation of the display 4340 within the coordinate space of the vehicle 4000), and distortion coefficients (e.g., the curvature of the display 4340). The operating parameters of the display 4340 may be used by the processor 4400 to perform transformations to the video imagery 4332.

As described above, the processor 4400 may be used to control the reactive system 4300. In the case of the video-based mirror 4320, the processor 4400 may communicate with the display 4340 and the camera 4330 using a high-speed communication bus based, in part, on the particular types of cameras 4330 and/or displays 4340 used (e.g., the bitrate of the camera 4330, resolution and/or refresh rate of the display 4340). In some cases, the communication bus may also be based, in part, on the type of processor 4400 used (e.g., the clock speed of a central processing unit and/or a graphics processing unit). The processor 4400 may also communicate with various components of the video-based mirror 4320 and/or other subsystems of the vehicle 4000 using a common communication bus, such as a Controller Area Network (CAN) bus.

The video-based mirror 4320 in the reactive system 4300 may acquire source video imagery 4332 that is modified based on the movement of the operator 4010 and shown as transformed video imagery 4342 on the display 4340. These modifications may include applying a transformation to the source video imagery 4332 that extracts an appropriate portion of the source video imagery 4332 and prepares the portion of the video imagery 4332 to be displayed to the operator 4010. In another example, transformations may be used to modify the FOV 4344 of the transformed video imagery 4342 such that the mirror 4320 responds in a manner similar to a conventional mirror. For instance, the FOV 4344 may widen as the operator 4010 moves closer to the display 4340. Additionally, the FOV 4344 of the transformed video imagery 4342 may pan as the operator 4010 shifts side to side.

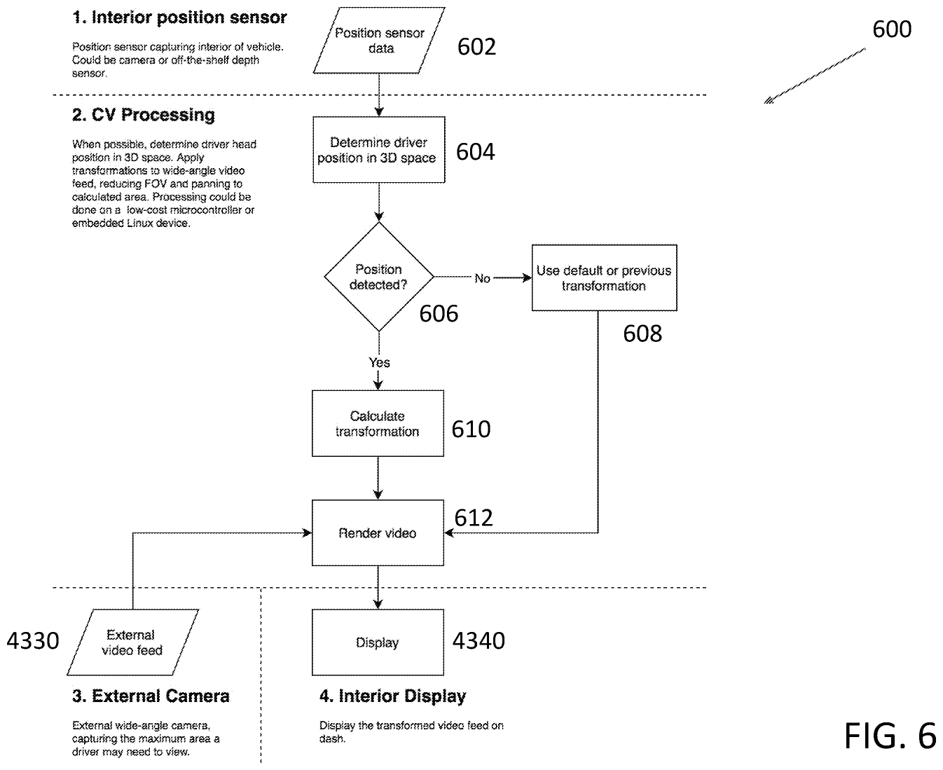

FIG. 6 shows a method 600 of transforming source video imagery 4332 acquired by the camera 4330 based, in part, on changes to the position and/or orientation of the head of the operator 4010. The method 600 may begin with sensing the position and/or orientation of the operator's head using the sensor 4200 (step 602). As described above, the sensor 4200 may acquire data of the operator's head (e.g., an RGB image and/or a depth map). The processor 4400 may then determine an ocular reference point of the operator 4010 based on the data acquired by the sensor 4200 (step 604). If the processor 4400 is able to determine the ocular reference point (step 606), a transformation is then computed and applied to modify the source video imagery 4332 (step 610).

The transformation may be calculated using a model of the video-based mirror 4320 and the sensor 4200 in the vehicle 4000. The model may receive various inputs including, but not limited to the ocular reference point, the operating parameters of the camera 4330 (e.g., intrinsic and extrinsic parameters, distortion coefficients), the operating parameters of the display 4340 (e.g., intrinsic and extrinsic parameters, distortion coefficients), and manufacturer and user calibration parameters. Various types of transformations may be applied to the source video imagery 4332 including, but not limited to panning, rotating, and scaling. The transformations may include applying a series of matrix transformations and signal processing operations to the source video imagery 4332.

In one example, the transformation applied to the source video imagery 4332 may be based only on the ocular reference point and the user calibration parameters. In particular, the distance between the ocular reference point and the default sitting position of the operator 4010 (as calibrated) may be used to pan and/or zoom in on a portion of the source video imagery 4332 using simple affine transformations. For instance, the magnitude of the transformation may be scaled to the calibrated range of motion of the operator 4010. Additionally, the pan and/or zoom rate may be constant such that the transformed video imagery 4342 responds uniformly to movement by the operator's head. In some cases, the uniform response of the mirror 4320 may not depend on the distance between the display 4340 and the ocular reference point of the operator 4010.

This transformation may be preferable in vehicles 4000 where the display(s) 4340 are located in front of the operator 4010 and/or when the mirror 4320 is configured to respond only to changes in the position of the operator's head (and not changes to other parameters such as the viewing angle of the operator 4010 or distance between the display 4340 and the operator 4010). In this manner, this transformation may be simpler to implement and less computationally expensive (and thus faster to perform) while providing a more standardized response for various camera 4330 and display 4340 placements in the vehicle 4000. Additionally, this transformation may be applied to the source video imagery 4332 based on movement of the operator's head.

In another example, the transformation applied to the source video imagery 4332 may be based, in part, on the viewing angle of the operator 4010 with respect to the display 4340 and the distance between the ocular reference point of the operator 4010 and the display 4340. A transformation that includes adjustments based on the position, viewing angle, and distance of the operator 4010 relative to the display 4340 may better emulate the behavior of traditional mirrors and, in turn, may feel more natural to the operator 4010. The processor 4400 may determine a vector, \vec{r}ₒₚₑᵣₐₜₒᵣ, from the ocular reference point of the operator 4010 to a center of the display 4340. The vector may then be used to determine a target FOV and pan position for the transformed video imagery 4342. For example, a ray casting approach may be used to define the FOV where rays are cast from the ocular reference point of the operator 4010 to the respective corners of the display 4340.

The next step is to extract a portion of the source video imagery 4332 corresponding to the target FOV. This may involve determining the location and size of the portion of source video imagery 4332 used for the transformed video imagery 4342. The size of the portion of source video imagery 4332 may depend, in part, on the angular resolution of the camera 4330 (e.g., degrees per pixel), which is one of the intrinsic parameters of the camera 4330. The angular resolution of the camera 4330 may be used to determine the dimensions of the portion of the video imagery 4332 to be extracted. For example, the horizontal axis of the target FOV may cover an angular range of 45 degrees. If the angular resolution of the camera 4330 is 0.1 degrees per pixel, the portion of the video imagery 4332 should have 450 pixels along the horizontal axis in order to meet the target FOV.

The location of the transformed video imagery 4342 extracted from the source video imagery 4332 captured by the camera 4330 may depend on the viewing angle of the operator 4010 with respect to the display 4340. The viewing angle may be defined as the angle between the vector \vec{r}ₒₚₑᵣₐₜₒᵣ and a vector, \vec{r}_{display}, that intersects and is normal to the center of the display 4340. Thus, collinearity of operator and \vec{r}_{display} would correspond to the ocular reference point of the operator 4010 being aligned to the center of the display 4340. As the operator's head moves, the resultant viewing angle may cause the location of the transformed video imagery 4342 to shift in position within the source video imagery 4332. The shift in position may be determined by multiplying the respective components of the viewing angle (i.e., a horizontal viewing angle and a vertical viewing angle) by the angular resolution of the camera 4330. In this manner, the center point (e.g., the X and Y pixel positions) of the cropped portion may be found with respect to the source video imagery 4332.

If the processor 4400 is unable to determine the ocular reference point of the operator 4010, a default or previous transformation may be applied to the source video imagery 4332 (step 608 in FIG. 6). For example, a previous transformation corresponding to a previous measurement of the ocular reference point may be maintained such that the transformed video imagery 4342 is not changed if the ocular reference point is not detected. In another example, a transformation may be calculated based on predictions of the operator's movement. If the ocular reference point is measured as a function of time, previous measurements may be extrapolated to predict the location of the ocular reference point of the operator 4010. The extrapolation of previous measurements may be accomplished in one or more ways including, but not limited to a linear extrapolation (e.g., the operator's movement is approximate as being linear with a sufficiently small time increment) and modeling of the operator's behaviors when performing certain actions (e.g., the operator's head moves towards the display 4340 in a substantially repeatable manner when changing lanes). In this manner, a sudden interruption to the detection of the ocular reference point would not cause the transformed video imagery 4342 to jump and/or appear choppy.

Once the transformation is determined (e.g., a new, calculated transformation, a default/previous transformation), the transformation is then applied to the source video imagery 4332 to generate the transformed video imagery 4342, which is then shown on the display 4340 (step 612 in FIG. 6). This method 600 of transforming source video imagery 4332 may be performed at operating frequencies of at least about 60 Hz. Additionally, the distortion coefficients of the camera 4330 and/or the display 4340 may be used to correct radial and/or tangential distortion of the source video imagery 4332. Various techniques may be used to correct distortion such as calculating the corrected pixel positions based on prior calibration and then remapping the pixel positions of the source video imagery 4332 (i.e., the source video stream) to the corrected pixel positions in the transformed video imagery 4342 (i.e., the transformed video stream).

As described above, the sensor 4200 and/or the reactive system 4300 may be calibrated to the operator 4010. For the video-based mirror 4320, calibration may include adjusting the transformed video imagery 4342 shown on the display 4340 to align with the operator's head, which may vary based on the operator's height and/or distance between the operator's head and the display 4340. Additionally, the operator's range of motion and/or default position (e.g., the operator's driving position in the vehicle 4000), as previously described, may be used to adjust the transformation applied to the source video imagery 4332. For example, the operator's range of motion may be used to scale the transformation such that the transformed video imagery 4342 is able to pan across the larger source video imagery 4332 (e.g., the FOV 4344 of the transformed video imagery 4342 may cover the FOV 4344 of the source video imagery 4332).

In another example, the operator's default position may be used as a “baseline” position. The baseline position may correspond to the operator 4010 having a preferred FOV of each display 4340 (i.e., in vehicles 4000 with more than one display 4340). For example, the transformed video imagery 4342 shown on each display 4340 may be substantially centered with respect to the source video imagery 4332 acquired by each corresponding camera 4330. In another example, the preferred FOV may depend on local regulations or manufacturer specifications for the vehicle 4000. In some cases, the default position of the operator 4010 may be determined using a dynamic calibration approach where the mirror 4320 adapts to different operators 4010 based on an averaged position of the operator 4010 (e.g., the average position when the operator 4010 is sitting) and/or the range of motion as the operator 4010 uses the vehicle 4000.

The calibration of the mirror 4320 may be performed in a semi-automated manner where the operator 4010 is instructed to perform certain actions (e.g., moving their extremities) in order to measure the range of motion and default position. As previously described, the operator 4010 may receive instructions for calibration using various systems, such as the infotainment system of the vehicle 4000 or the vehicle's speakers. For the video-based mirror 4320, the display 4340 may also be used to provide visual instructions and/or cues to the operator 4010. The instructions and/or cues may include one or more overlaid graphics of the vehicle 4000, the road, and/or another reference object that provides the operator 4010 a sense of scale and orientation. Once these measurements are performed, the processor 4400 may attempt to adjust the transformed video imagery 4342 shown on each display 4340 in order to provide a suitable FOV of the vehicle surroundings.

The operator 4010 may also be provided controls to directly adjust the mirror 4320. In this manner, the operator 4010 may calibrate the mirror 4320 according to their personal preferences similar to how a driver is able to adjust the side-view or rear-view mirrors of a vehicle. Various control inputs may be provided to the operator 4010 including, but not limited to touch controls (e.g., the infotainment system, the display 4340), physical buttons, and a joystick. The control inputs may allow the operator 4010 to manually pan the transformed video imagery 4342 up, down, left and right and/or adjust a magnification factor offset to increase/decrease magnification of the transformed video imagery 4342.

These adjustments may be performed by modifying the transformations applied to the source video imagery 4332 (e.g., adjusting the size and location of the transformed video imagery 4342 extracted from the source video imagery 4332) and/or by physically rotating and/or panning the camera 4330. Additionally, the extent to which the transformed video imagery 4342 may be panned and/or scaled by the operator 4010 may be limited, in part, by the source FOV 4334 and the resolution of the source video imagery 4332. In some cases, local regulations may also impose limits to the panning and/or scaling adjustments applied to the transformed video imagery 4342. Furthermore, these manual adjustments may be made without the operator 4010 being positioned in a particular manner (e.g., the operator 4010 does not need to be in the default position).

After the mirror 4320 is calibrated, the operator's default position, range of motion, and individual offsets for each mirror 4320 in the vehicle 4000 may be stored. Collectively, these parameters may define the “center point” of each display 4340, which represents the FOV of the environment shown to the operator 4010 in the default position when controlling the vehicle 4000. The center point may be determined using only the default sitting position and the offsets for each display 4340. In some cases, the center point may correspond to a default FOV 4344 of the transformed video imagery 4342 when the ocular reference point of the operator 4010 is not detected.

The range of motion of the operator 4010 may be used to scale the rate the transformed video imagery 4342 is panned and/or scaled. Additionally, the range of motion may be constrained and/or otherwise obscured by the cabin of the vehicle 4000. Thus, adjusting the magnification scale factor of the transformed video imagery 4342 may depend, in part, on the detectable range of motion of the operator 4010 in the cabin of the vehicle 4000. If the operator 4010 cannot be located with sufficient certainty and within a predefined time period, the mirror 4320 may default to showing transformed video imagery 4342 corresponding to the calibrated center point of each display 4340.

A Reactive System with an Articulated Joint

The reactive system 4300 may also include an articulated joint that changes the physical configuration of the vehicle 4000 based, in part, on the behavior of the operator 4010. For example, the articulated joint may be part of an active suspension system on the vehicle 4000 that adjusts the distance between the wheel and the chassis of the vehicle 4000. The vehicle 4000 may include multiple, independently controlled articulated joints for each wheel to change the ride height and/or to tilt the vehicle 4000. In another example, the articulated joint may change the form and/or shape of the body 4100. This may include an articulated joint that actuates a flatbed of a truck.

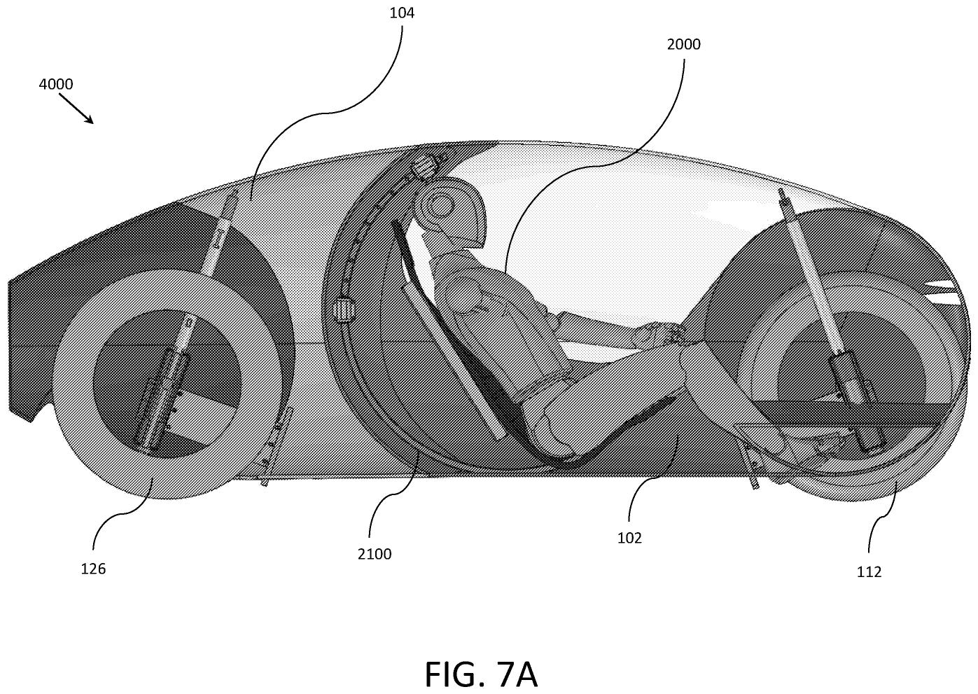

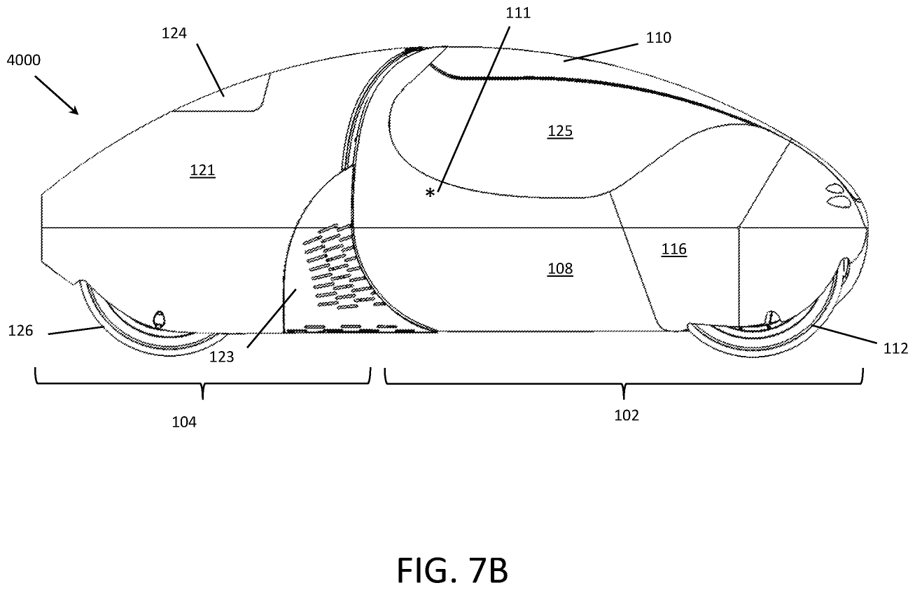

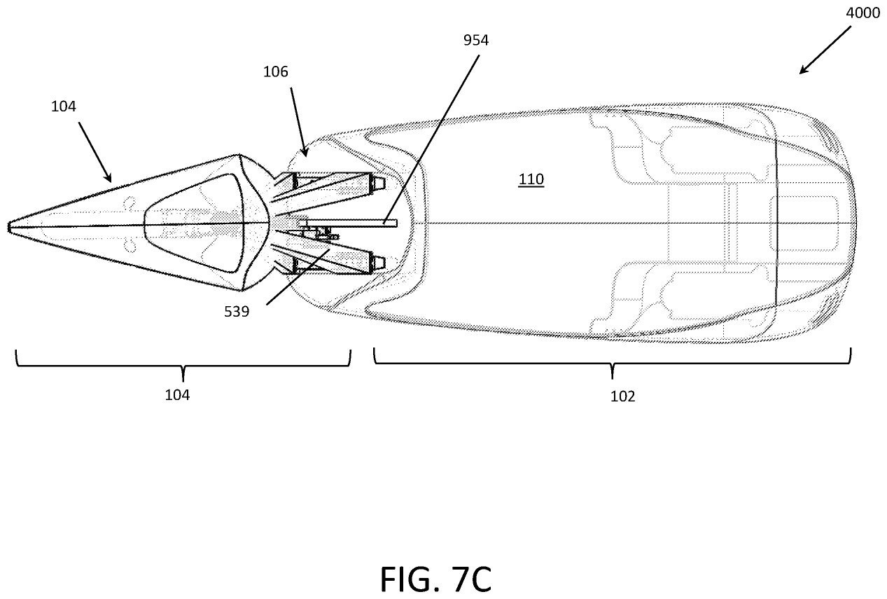

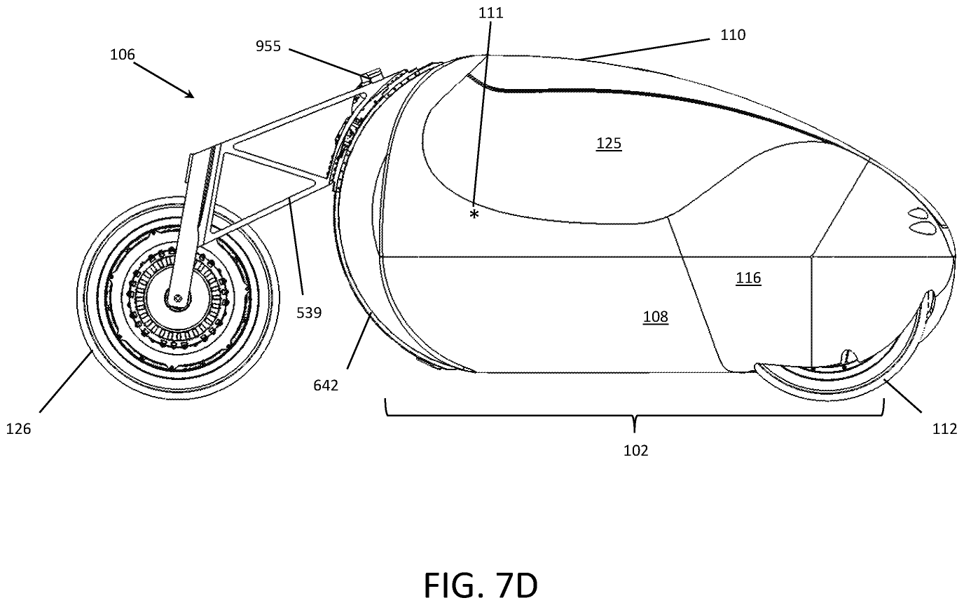

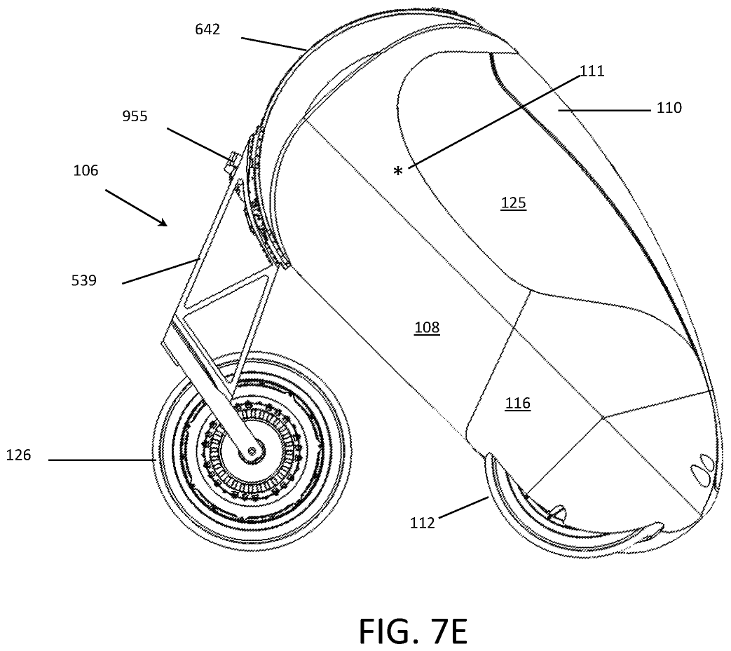

Additionally, the articulated joint may bend and/or otherwise contort various sections of the body 4100 (see exemplary vehicle 4000 in FIGS. 7A-7E). For example, one or more articulated joints and/or other actuators may actuate the payload support mechanism rather than the vehicle itself. For example, these actuators may adjust the position and recline angle of the seat to maximize comfort and/or visibility specifically for an individual operator without necessarily articulating the vehicle. The seat adjustment can be performed shortly after or in anticipation of the operator entering the vehicle. Subsequent adjustments to the seat portion and recline angle may be performed while the vehicle is moving, as the operator settles in over time. In such a scenario, it may be inefficient or unsafe to articulate the vehicle.

The articulation of both the vehicle's body 4100 and actuation of its suspension may enable several configurations that each provide certain desirable characteristics to the performance and/or operation of the vehicle 4000. The vehicle 4000 may be configured to actively transition between these configurations based on changes to the position and/or orientation of the operator 4010 as measured by the sensor 4200. In some cases, a combination of explicit inputs by the operator 4010 (e.g., activating a lane change signal, lowering the window) and operator behavior may control the response of the articulated joint(s) in the vehicle 4000.

For example, the vehicle 4000 may support a low profile configuration where the height of the vehicle 4000 is lowered closer to the road (see FIG. 7D). The low configuration may provide improved aerodynamic performance by reducing the coefficient of drag and/or reducing the frontal area of the vehicle 4000. The low profile configuration may also increase the wheelbase and/or lower the center of gravity of the vehicle 4000, which improves driving performance by providing greater stability and cornering rates. The processor 4400 may transition and/or maintain the vehicle 4000 at the low profile configuration when the processor 4400 determines operator 4010 is focused on driving the vehicle 4000 (e.g., the ocular reference point indicate the operator 4010 is focused on the surroundings directly in front of the vehicle 4000) and/or driving at high speeds (e.g., on a highway).

In another example, the vehicle 4000 may support a high profile configuration where the height of the vehicle 4000 is raised above the road (see FIG. 7E). The high profile configuration may be used to assist with ingress and/or egress of the vehicle 4000. If combined with an articulated seat mechanism, the seat (or more generally a cargo carrying platform) may be presented at a height appropriate for the operator 4010 (e.g., a worker, a robotic automaton) to access a payload stored in the vehicle 4000. An elevated position may also increase the FOV of the operator 4010 and/or any sensors disposed on the vehicle 4000 to monitor the surrounding environment, thus increasing situational awareness. The processor 4400 may transition and/or maintain the vehicle 4000 at the high profile configuration when the FOV of the operator 4010 is blocked by an obstruction in the environment (e.g., another vehicle, a barrier, a person) and/or the processor 4400 determines the operator 4010 is actively trying to look around an obstruction (e.g., the ocular reference point indicates the operator's head is oriented upwards to look over the obstruction).

The vehicle 4000 may also support a medium profile configuration, which may be defined as an intermediate state between the low and high profile configurations previously described. The medium profile configuration may thus provide a mix of the low profile and high profile characteristics. For example, the medium profile configuration may provide better visibility to the operator 4010 while maintaining a low center of gravity for improved dynamic performance. This configuration may be used to accommodate a number of scenarios encountered when operating the vehicle 4000 in an urban environment and/or when interacting with other vehicles or devices.

Various use cases of the medium profile configuration include but are not limited to adjusting the ride height to facilitate interaction with a mailbox, an automatic teller machine (ATM), a drive-through window, and another human standing on the side of the road (e.g., a neighbor or cyclist). If the vehicle 4000 is used to transport cargo (perhaps autonomously), the intermediate state allows for better ergonomic and mechanical interaction with delivery and/or loading docks, robots, and humans. These use cases may involve predictable movement of the operator 4010 (or the cargo). For example, the operator 4010 may lower the window and stick their hand out to interact with an object or person in the environment. If the sensor 4200 detects the window is lowered and the processor 4400 determines the operator 4010 is sticking their hand out, the processor 4400 may adjust the height of the vehicle 4000 to match the height of an object detected near the driver side window.

FIGS. 7A-7E show the vehicle 4000 that incorporates an articulated joint 106 (also called an articulation mechanism), a morphing section 123, and a payload positioning joint 2100 (also called a payload positioning mechanism) to support a payload 2000 (e.g., a driver, a passenger, cargo). In this example, the vehicle 4000 is a three-wheeled electric vehicle with rear wheel steering. The articulated joint 106 enables the vehicle 4000 to articulate or bend about an intermediate position along the length of the vehicle 4000, thus reconfiguring the vehicle 4000.

The range of articulation of the vehicle 4000 may be defined by two characteristic configurations: (1) a low profile configuration where the wheelbase is extended and the driver is near the ground as shown in FIGS. 7A, 7B, 7D and (2) a high profile configuration where the driver is placed at an elevated position above the ground as shown in FIG. 7E. The vehicle 4000 may be articulated to any configuration between the low profile and the high profile configurations. In some cases, the articulated joint 106 may limit the vehicle 4000 to a discrete number of configurations. This may be desirable in instances where a simpler and/or a low power design for the articulated joint 106 is preferred.

The vehicle 4000 may be subdivided into a front vehicle section 102 and a tail section 104, which are coupled together by the articulated joint 106. The front section 102 may include a body 108, which may be various types of vehicle support structures including, but not limited to a unibody, a monocoque frame/shell, a space frame, and a body-on-frame construction (e.g., a body mounted onto a chassis). In FIGS. 7A-7E, the body 108 is shown as a monocoque frame. The body 108 may include detachable side panels (or wheel fairings) 116, fixed side windows 125, a transparent canopy 110 coupled to the vehicle 4000, and two front wheels 112 arranged in a parallel configuration and mounted on the underlying body 108. The tail section 104 may include a rear outer shell 121, a rear windshield 124, and a steerable wheel 126. A morphing section 123 may be coupled between the front section 102 and the tail section 104 to maintain a smooth, continuous exterior surface underneath the vehicle 4000 at various configurations. In FIGS. 7D and 7E, the rear outer shell 121 and the rear windshield 124 are removed so that underlying components related to at least the articulated joint 106 can be seen.

The canopy 110 may be coupled to the body 108 via a hinged arrangement to allow the canopy 110 to be opened and closed. In cases where the payload 2000 is a driver, the canopy 110 may be hinged towards the top of the vehicle 4000 when in the high profile configuration of FIG. 7E so that the driver may enter/exit the vehicle 4000 by stepping into/out of the vehicle 4000 between the two front wheels 112.

The front wheels 112 may be powered by electric hub motors. The rear wheel 126 may also be powered by an electric hub motor. Some exemplary electric motors may be found in U.S. Pat. No. 8,742,633, issued on Jun. 14, 2014 and entitled “Rotary Drive with Two Degrees of Movement” and U.S. Pat. Pub. 2018/0072125, entitled “Guided Multi-Bar Linkage Electric Drive System”, both of which are incorporated herein by reference in their entirety.

The rear surface of the front vehicle section 102 may be nested within the rear outer shell 121 and shaped such that the gap between the rear outer shell 121 of the tail section 104 and the rear surface of the front vehicle section 102 remains small as the tail section 104 moves relative to the front section 102 via the articulated joint 106. As shown, the articulated joint 106 may reconfigure the vehicle 4000 by rotating the tail section 104 relative to the front section 102 about a rotation axis 111. In FIGS. 7B, 7C, and 7E, the axis of rotation 111 is perpendicular to a plane, which bisects the vehicle 4000. The plane may be defined to contain (1) a longitudinal axis of the vehicle 4000 (e.g., an axis that intersects the frontmost portion of the body 108 and the rearmost portion of the rear outer shell 121) and (2) a vertical axis normal to a horizontal surface onto which the vehicle 4000 rests such.

The articulated joint 106 may include a guide structure 107 (also called a guide mechanism) that determines the articulated motion profile of the articulated joint 106. In the exemplary vehicle 4000 shown in FIGS. 7A-7E, the guide structure 107 may include a track system coupled to the front section 102 and a carriage 538 coupled to the tail section 104. Alternatively, the track system 536 may be coupled to tail section 104 and the carriage 538 coupled to the front section 102. The carriage 538 may move along a path defined by the track system 536, thus causing the vehicle 4000 to change configuration. The articulated joint 106 may also include a drive actuator 540 (also called a drive mechanism) that moves the carriage 538 along the track system 536 to the desired configuration. The drive actuator 540 may be electrically controllable. The articulated joint 106 may also include a brake 1168 to hold the carriage 538 at a particular position along the track system 536, thus allowing the vehicle 4000 to maintain a desired configuration.

The body 108 may also contain therein a payload positioning joint 2100. The payload positioning joint 2100 may orient the payload 2000 to a preferred orientation as a function of the vehicle 4000 configuration. As the articulated joint 106 changes the configuration of the vehicle 4000, the payload positioning joint 2100 may simultaneously reconfigure the orientation of the payload 2000 with respect to the vehicle 4000 (the front section 102 in particular). For example, the payload positioning joint 2100 may be used to maintain a preferred driver orientation with respect to the ground such that the driver does not have to reposition their head as the vehicle 4000 transitions from the low profile configuration to the high profile configuration. In another example, the payload positioning joint 2100 may be used to maintain a preferred orientation of a package to reduce the likelihood of damage to objects contained within the package as the vehicle 4000 articulates.

The vehicle 4000 shown in FIGS. 7A-7E is one exemplary implementation of the articulated joint 106, the morphing section 123, and the payload positioning joint 2100. Various designs for the articulated joint 106, the morphing section 123, and the payload positioning joint 2100, are respectively discussed with reference to the vehicle 4000. However, the articulated joint 106, the morphing section 123, and the payload positioning joint 2100 may be implemented in other vehicle architectures either separately or in combination.

The articulated vehicle 4000 in FIGS. 7A-7E is shown to have a single articulation DOF (i.e., the rotation axis 111) where the tail section 104 rotates relative to the front section 102 in order to change the configuration of the vehicle 4000. This topology may be preferable for a single commuter or passenger traveling in both urban environments and the highway, especially when considering intermediate and endpoint interactions with the surrounding environment (e.g., compact/nested parking, small space maneuverability, low speed visibility, high speed aerodynamic form). The various mechanisms that provide support for said topology and use cases may be applied more generally to a broader range of vehicles, fleet configurations, and/or other topologies.

For instance, the vehicle 4000 may support one or more DOF's that may each be articulated. Articulation may occur about an axis resulting in rotational motion, thus providing a rotational DOF, such as the rotation axis 111 in FIGS. 7A-7E. Articulation may also occur along an axis resulting in translational motion and thus a translational DOF. The various mechanisms described herein (e.g., the articulated joint 106, the payload positioning joint 2100) may also be used to constrain motion along one or more DOF's. For example, the articulated joint 106 may define a path along which a component of the vehicle 4000 moves along said path (e.g., the carriage 538 is constrained to move along a path defined by the track system 536). The articulated joint 106 may also define the range of motion along the path. This may be accomplished, in part, by the articulated joint 106 providing smooth motion induced by low force inputs along a desired DOF while providing mechanical constraints along other DOF's using a combination of high strength and high stiffness components that are assembled using tight tolerances and/or pressed into contact via an external force.

The mechanisms described here may define motion with respect to an axis or a point (e.g., a remote center of motion) that may or may not be physically located on the articulated joint 106. For example, the articulated joint 106 shown in FIGS. 7A-7E causes rotational motion about the rotation axis 111, which intersects the interior compartment of the body 108, which is located separately from the carriage 538 and the track system 536. In another example, the payload positioning joint 2100 may have one or more rails 2112 that define the translational motion of a platform (e.g., a driver's seat).

Additionally, motion along each DOF may also be independently controllable. For example, each desired DOF in the vehicle 4000 may have a separate corresponding articulated joint 106. The drive system of each articulated joint 106 may induce motion along each DOF independently from other DOF's. With reference to FIGS. 7A-7E, the articulated joint 106 that causes rotation about the rotation axis 111 may not depend on other DOF's supported in the vehicle 4000.

In some cases, however, articulation along one DOF of the vehicle 4000 may be dependent on another DOF of the vehicle 4000. For example, one or more components of the vehicle 4000 may move relative to another component in response to the other component being articulated. This dependency may be achieved by mechanically coupling several DOF's together (e.g., one articulated joint 106 is mechanically linked to another articulated joint 106 such that a single drive actuator 540 may actuate both articulated joints 106 sequentially or simultaneously). Another approach is to electronically couple separate DOF's by linking separate drive actuators 540 together. For example, the payload positioning joint 2100 may actuate a driver seat using an onboard motor in response to the articulated joint 106 reconfiguring the vehicle 4000 so that the driver maintains a preferred orientation as the vehicle 4000 is reconfigured.

The articulated joint 106 may generally include a guide structure 107 that defines the motion profile and, hence, the articulation DOF of the articulated joint 106. The guide structure 107 may include two reference points that move relative to one another. A first reference point may be coupled to one component of the vehicle 4000 whilst a second reference point may be coupled to another component of the vehicle 4000. For example, the front section 102 may be coupled to a first reference point of the guide structure 107 and the tail section 104 may be coupled to a second reference point of the guide structure 107 such that the front section 102 is articulated relative to the tail section 104.

In one aspect, the guide structure 107 may provide articulation about an axis and/or a point that is not physically co-located with the articulated joint 106 itself. For example, the articulated joint 106 may be a remote center of motion (RCM) mechanism. The RCM mechanism is defined as having no physical revolute joint in the same location as the mechanism that moves. Such RCM mechanisms may be used, for instance, to provide a revolute joint located in an otherwise inconvenient portion of the vehicle 4000, such as the interior cabin of the body 108 where the payload 2000 is located or a vehicle subsystem, such as where a steering assembly, battery pack, or electronics resides.

The following describes several examples of the articulated joint 106 as an RCM mechanism. However, the articulated joint 106 may not be an RCM mechanism where the axis or point about which the DOF is defined along may be located physically with the components of the articulated joint 106.

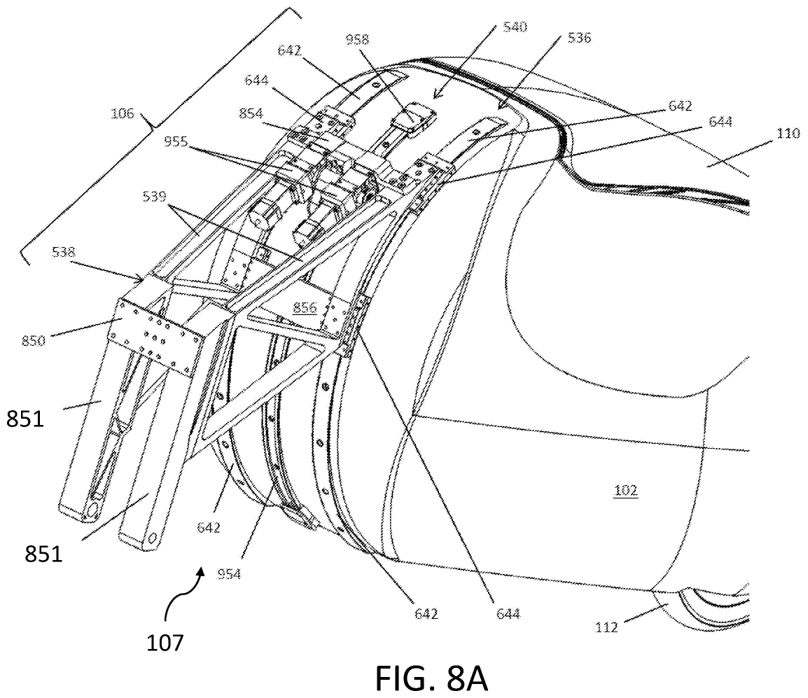

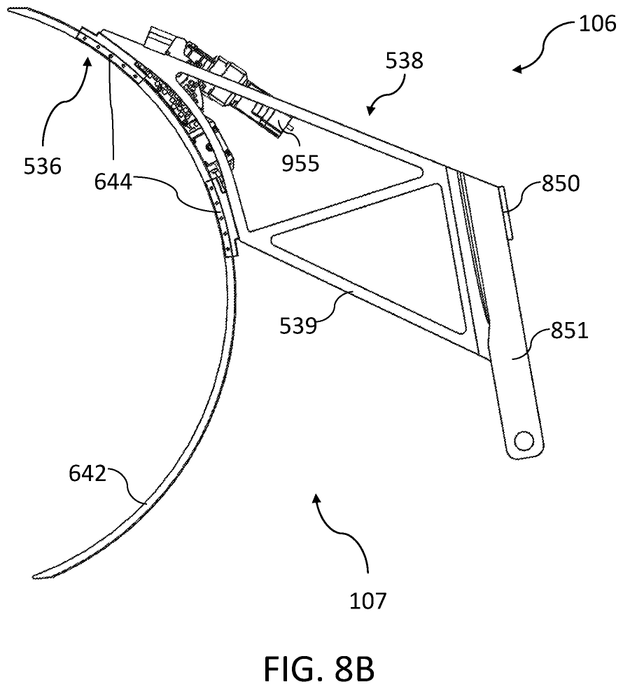

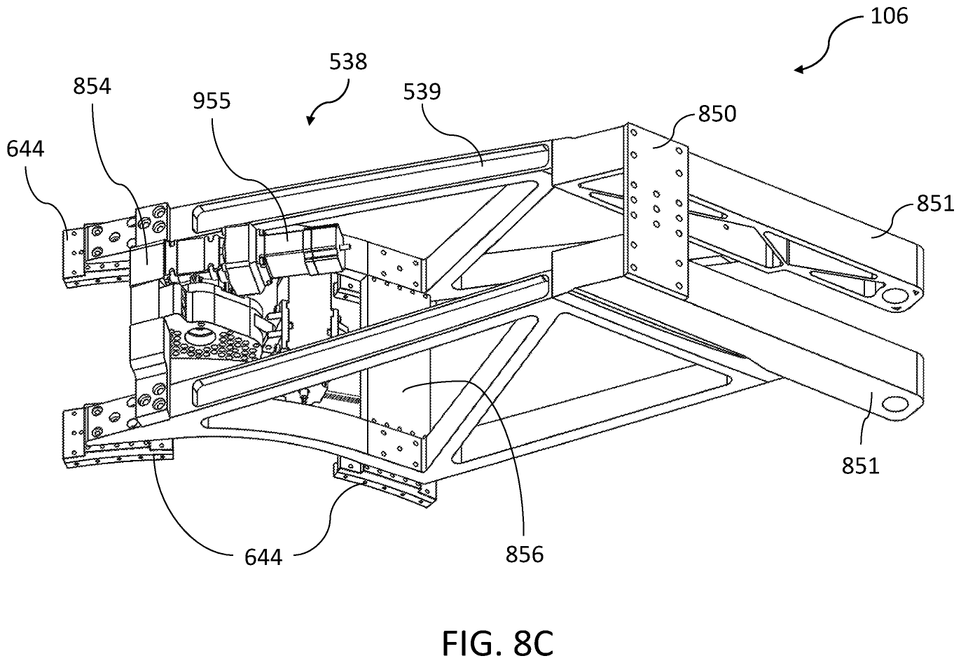

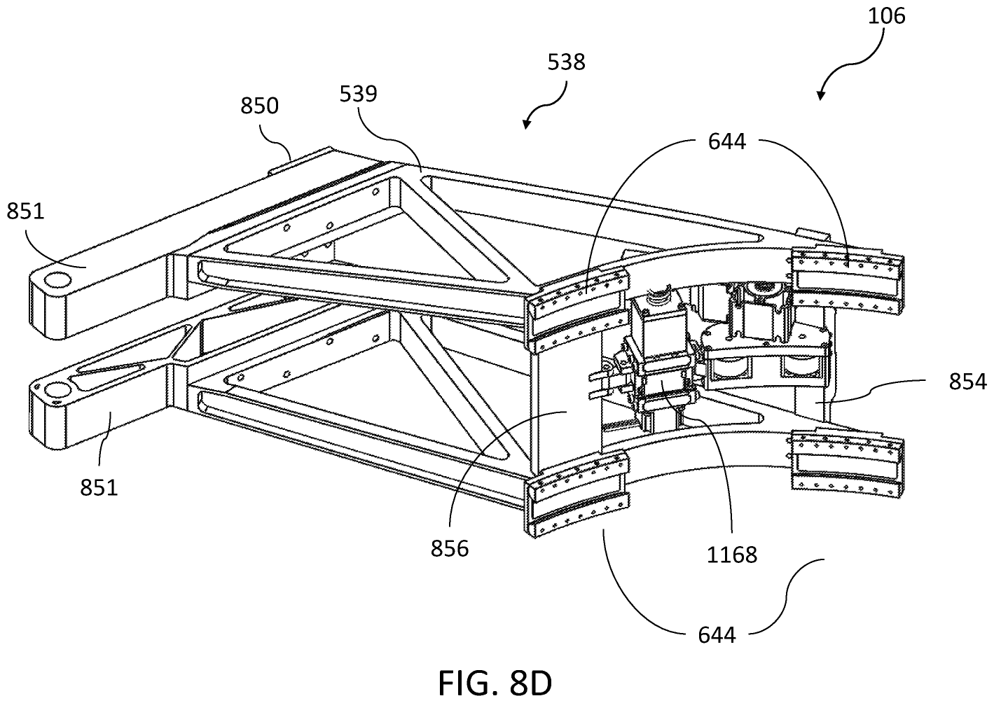

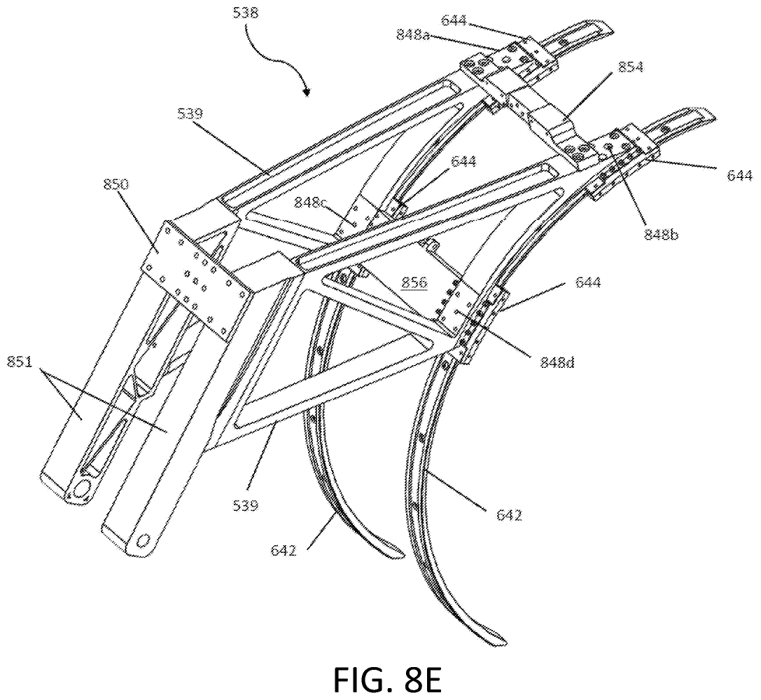

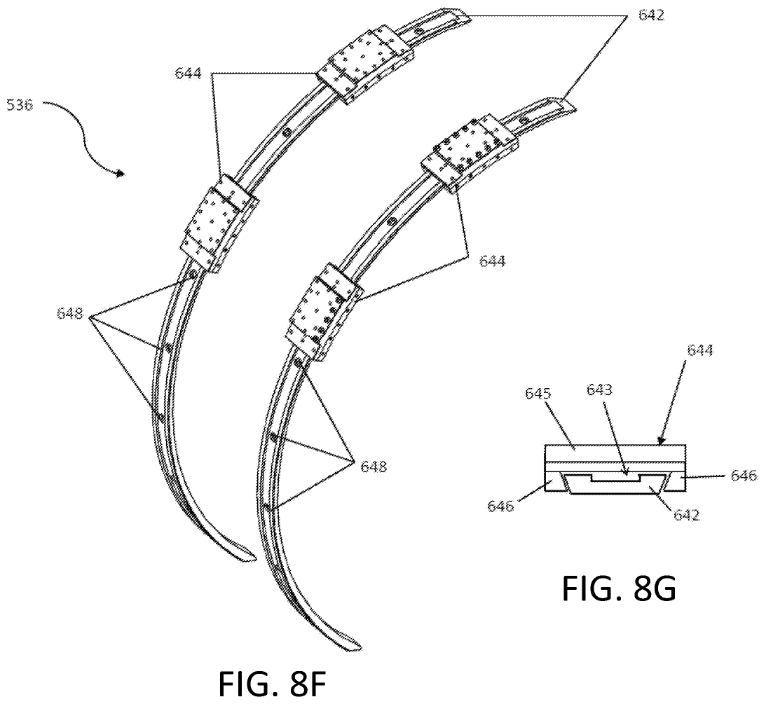

In one example, the guide structure 107 may be a carriage-track type mechanism. The articulated joint 106 shown in FIGS. 7A-7E is one example of this type of mechanism. The guide structure 107 may include the carriage and the track system 536, which are shown in greater detail in FIGS. 8A-8G. As shown in FIG. 8A, the track system 536 may be attached to the front section 102. The carriage 538 may be part of the tail section 104. As shown in FIGS. 8E and 8F, the carriage 538 may ride along a vertically oriented, curved path defined by the track system 536. The drive actuator 540 may be mounted on the carriage 538 to mechanically move the carriage 538 along the track system 536 under electrical control.

The track system 536 may include two curved rails 642 that run parallel to each other and are both coupled to a back surface of the front vehicle section 102. The curved rails 642 may be similar in design. The body 108 may be made from a molded, rigid, carbon fiber shell with a convexly curved rear surface that forms the back surface onto which the rails 642 are attached (i.e., convex with respect to viewing the front vehicle section 102 from the back). The region of the back surface onto which the rails 642 are attached and to which they conform represents a segment of a cylindrical surface for which the axis corresponds to the axis of rotation 111. In other words, the rails 642 may have a constant radius of curvature through the region over which the carriage 538 moves. The arc over which the rails 642 extend may be between about 90° to about 120°.

Each rail 642 may also include a recessed region 643 that spans a portion of the length of the rail 642. The recessed region 643 may include one or more holes Z through which bolts (not shown) can attach the rail 642 to the carbon fiber shell 108. Each rail 642 may have a cross-section substantially shaped to be an isosceles trapezoid where the narrow side of the trapezoid is on the bottom side of the rail 642 proximate to the front body shell 108 to which it is attached and the wider side of the trapezoid on the top side of the rail 642. The rails 642 may be made of any appropriate material including, but not limited to aluminum, hard-coated aluminum (e.g., with titanium nitride) to reduce oxidation, carbon fiber, fiberglass, hard plastic, and hardened steel.

The carriage 538 shown in FIGS. 8A and 8E supports the tail section 104 of the vehicle 4000. The tail section 104 may further include the rear shell 121, the steering mechanism 200, and the wheel assembly 201. The carriage 538 may be coupled to the track system 536 using one or more bearings. As shown in FIG. 8G, two bearings 644 are used for each rail 642. Each bearing 644 may include an assembly of three parts: an upper plate 645 and two tapered side walls 646 fastened to the upper plate 645. The assembled bearing 644 may define an opening with a cross-section substantially similar to the rail 642 (e.g., an isosceles trapezoid), which may be dimensioned to be slightly larger than the rail 642 to facilitate motion during use. The bearing 644, as shown, may thus be coupled to the rail 642 to form a “curved dovetail” arrangement where the inner sidewalls of the bearing 644 may contact the tapered outer sidewalls of the rail 642. The bearing 644 may not be separated from the rail 642 along any other DOF besides the desired DOF defined by rotational motion about the rotation axis 111. FIG. 8G shows an exaggerated representation of the tolerances between the bearing 644 and the rail 642 for purposes of illustration. The tolerances, in practice, may be substantially smaller than shown. The plate 645 and the side walls 646 may be curved to conform to the curved rail 642.

In one example, the bearing 644 may be a plain bearing where the inner top and side surfaces of the bearing 644 slide against the top and side wall surfaces, respectively, of the rail 642 when mounted. The bearing 644 may also include screw holes in the top plate to couple (e.g., via bolts) the remainder of the carriage 538 to the track system 536.

The length of the bearing 644 (e.g., the length being defined along a direction parallel to the rail 642) may be greater than the width of the bearing 644. The ratio of the length to the width may be tuned to adjust the distribution of the load over the bearing surfaces and to reduce the possibility of binding between the bearing 644 and the rail 642. For example, the ratio may be in the range between about 3 to about 1. The bearing 644 may also have a low friction, high force, low wear working surface (e.g., especially the surface that contacts the rail 642). For example, the working surface of the bearing 644 may include, but is not limited to a Teflon coating, a graphite coating, a lubricant, and a polished bearing 644 and/or rail 642. Additionally, multiple bearings 644 may be arranged to have a footprint with a length to width ratio of ranging between about 1 to about 1.6 in order to reduce binding, increase stiffness, and increase the range of motion. Typically, a bearing 644 with a longer base may have a reduced range of motion whereas a bearing 644 with a narrower base may have a lower stiffness; hence, the length of the bearing 644 may be chosen to balance the range of motion and stiffness, which may further depend upon other constraints imposed on the bearing 644 such as the size and/or the placement in the vehicle 4000.

The carriage 538 may further include two frame members 539, where each frame member 539 is aligned to a corresponding rail 642. On the side of the carriage 538 proximate to the rails 642, two cross bars 854 and 856 may be used to rigidly connect the two frame members 539 together. The bearings 644 may be attached to the frame members 539 at four attachment points 848a-d. On the side of the carriage 538 furthest from the rails 642, two support bars 851 may be used to support the wheel assembly 201 and the steering mechanism 200. The two support bars 851 may be connected together by another cross bar 850.

The carriage 538 and the track system 536 described above is just one example of a track-type articulated joint 106. Other exemplary articulated joints 106 may include a single rail or more than two rails. As shown above, the RCM may be located in the cabin of the vehicle 4000 where the payload 2000 is located without having any components and/or structure that intrudes into said space. However, in other exemplary articulated joints 106, the RCM may be located elsewhere with respect to the vehicle 4000 including, but not limited to, on the articulated joint 106, in vehicle subsystems (e.g., in the front section 102, in the tail section 104), and outside the vehicle 4000.

As described above, the articulated joint in the reactive system 4300 may change the physical configuration of the vehicle 4000 in order to modify some aspect and/or characteristic of the vehicle 4000, such as the operator's FOV. However, in some cases, the articulated joint may be capable of modifying the physical configuration of the vehicle 4000 to such an extent that the vehicle 4000 becomes mechanically unstable, which may result in a partial or complete loss of control of the vehicle 4000. In order to prevent such a loss of stability when operating the vehicle 4000, the reactive system 4300 may include a stability control unit that imposes constraints on the articulated joint (e.g., limiting the range of actuation, limiting the actuation rate).

For example, the operator 4010 may lean to one side of the vehicle 4000 when changing lanes in order to adjust their viewing angle of a rear view display, thus enabling the operator 4010 to check whether any vehicles are approaching from behind. In response to the operator's movement, the articulated joint of the vehicle 4000 may actively roll the vehicle 4000 in order to increase the FOV available to the operator 4010. However, the amount of roll commanded by the processor 4400 to enhance the FOV may be limited or, in some instances, superseded by the stability control unit in order to prevent a loss of vehicle stability and/or the vehicle 4000 from rolling over.

The constraints imposed by the stability control unit on the articulated joint may vary based on the operating conditions of the vehicle 4000. For instance, the stability control unit may impose more limits on the amount of roll permissible when the vehicle 4000 is traveling at low speeds (e.g., changing lanes in traffic) compared to high speeds (e.g., a gyroscopic stabilizing effect of the spinning wheels provides greater vehicle stability). In this manner, the stability control unit may preemptively filter actuator commands for the articulated joint intended to improve operator comfort if vehicle stability is affected.

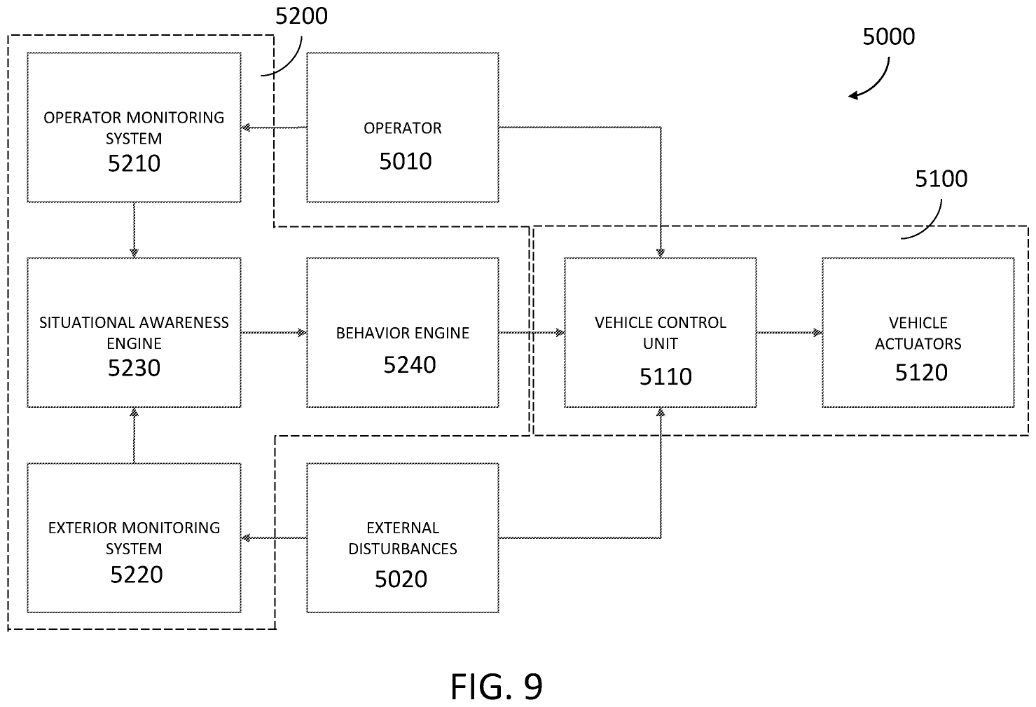

FIG. 9 depicts an exemplary control system 5000 that manages the operation of the articulated joint in the reactive system 4300. As shown, the control system 5000 includes a behavioral control subsystem 5200 that generates a behavior-based command based, in part, on an operator's action. The control system 5000 may also include a vehicle control subsystem 5100 that receives inputs from the operator 4010, the environment 4500, and the behavioral control subsystem 5200 and generates a command based on the inputs that is then used to actuate the various actuators in the vehicle 4000 including the articulated joint.

The vehicle control subsystem 5100 may operate similarly to previous vehicle control systems. For example, the subsystem 5100 receives commands by the operator 4010 (e.g., a steering input, an accelerator input, a brake input) and the environment 4500 (e.g., precipitation, temperature) and assesses vehicle stability and/or modifies the commands before execution. Thus, the vehicle control subsystem 5100 may be viewed as being augmented by the behavioral control subsystem 5200, which provides additional functionality such as articulation of the vehicle 4000 based on the operator's behavior.

The control system 5000 may receive operator-generated inputs 5010 and environmentally generated inputs 5020. The operator-generated inputs 5010 may include explicit commands, i.e., commands originating from the operator 4010 physically interfacing with an input device in the vehicle 4000, such as a steering wheel, an accelerator pedal, a brake pedal, and/or a turn signal knob. The operator-generated inputs 5010 may also include implicit commands, e.g., commands generated based on the movement of the operator 4010, such as the operator 4010 tilting their head to check a rear view display and/or the operator 4010 squinting their eyes due to glare. The environmentally generated inputs 5020 may include various environmental conditions affecting the operation of the vehicle 4000, such as road disturbances (e.g., potholes, type of road surface), weather-related effects (e.g., rain, snow, fog), road obstructions (e.g., other vehicles, pedestrians), and/or the operator 4010 when not inside the vehicle 4000.

As shown in FIG. 9, the operator-generated inputs 5010 and the environmentally generated inputs 5020 may each be used as inputs for both the vehicle control subsystem 5100 and the behavioral control subsystem 5200. The behavioral control subsystem 5200 may include an operating monitoring system 5210 and an exterior monitoring system 5220 that includes various sensors, human interface devices, and camera arrays to measure the operator-generated inputs 5010 (both explicit and implicit commands) and the environmentally generated inputs 5020. The behavioral control subsystem 5200 may also include a situational awareness engine 5230 that processes and merges the operator-generated inputs 5010 and the environmentally generated inputs 5020. The situational awareness engine 5230 may also filter the inputs 5010 and 5020 to reduce the likelihood of unwanted articulation of the vehicle 4000 (e.g., the articulated joint should not be activated when the operator is looking at a passenger or moving their head while listening to music).

The situational awareness engine 5230 may transmit the combined inputs to a behavior engine 5240, which attempts to identify pre-defined correlations between the combined inputs and calibrated inputs associated with a particular vehicle behavior. For example, various inputs (e.g., the steering wheel angle, the tilt of the operator's head, the gaze direction of the operator 4010, and/or the presence of a turn signal) may exhibit characteristic values when the vehicle 4000 is turning.

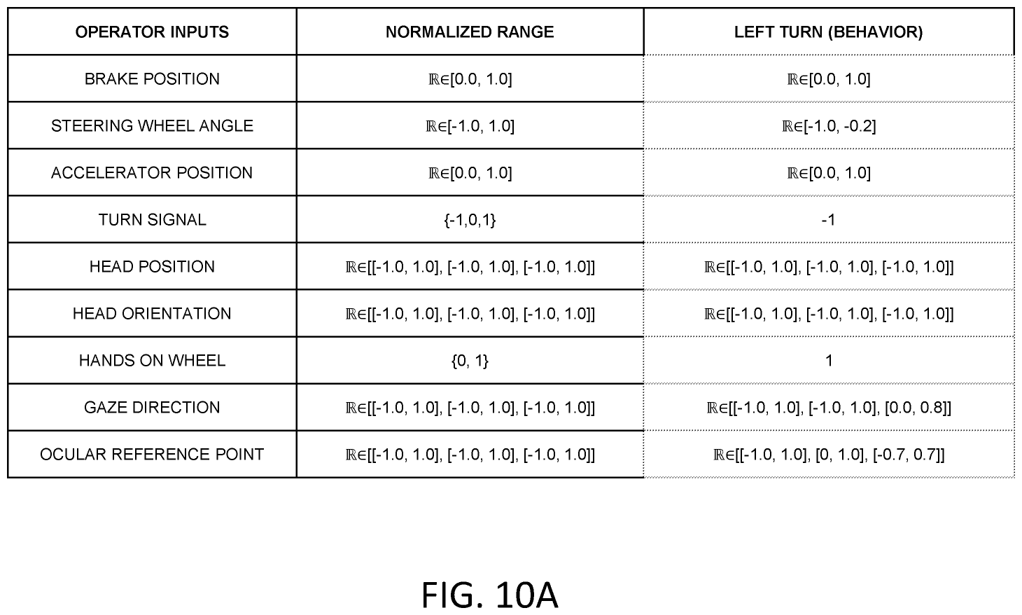

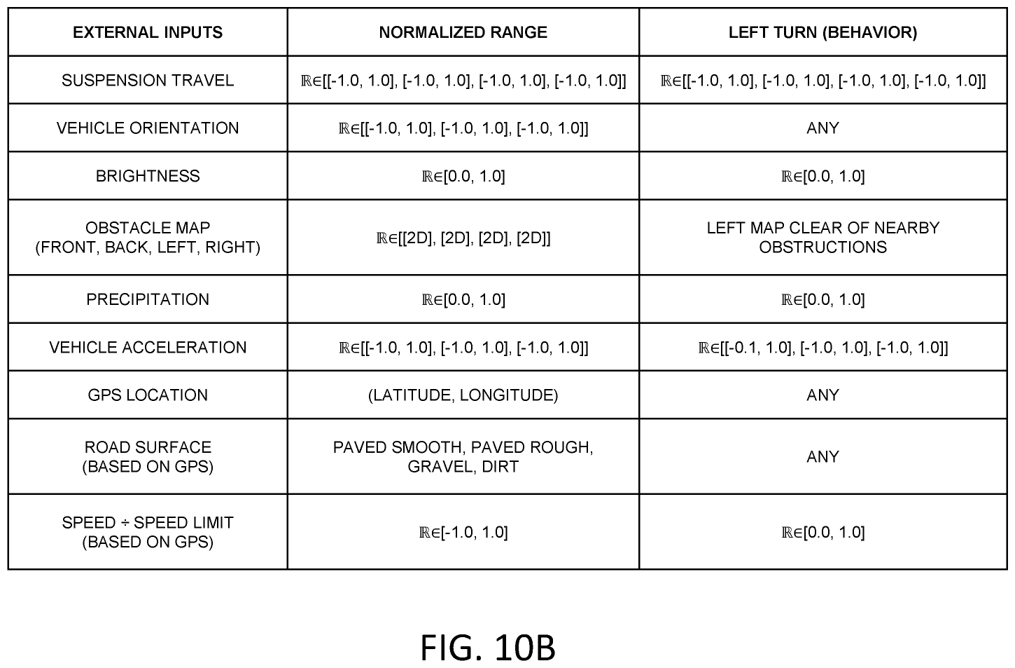

FIGS. 10A and 10B show respective tables of various exemplary operator-generated inputs 5010 and environmentally generated inputs 5020, respectively, comparing the nominal range of the various inputs and the input values associated with the vehicle 4000 making a left turn. If the behavior engine 5240 determines the combined inputs have values that are substantially similar to the characteristic input values associated the vehicle 4000 turning left, then the behavior engine may conclude the vehicle 4000 is turning left and generate an appropriate behavior-based command. Otherwise, the behavior engine 5240 may produce no behavior-based command.

The behavior engine 5240 may perform this comparison between the combined inputs and calibrated inputs associated with a particular vehicle behavior in several ways. For example, the combined inputs may be represented as a two-dimensional matrix where each entry corresponds to a parameter value. The behavior engine 5240 may perform a cross-correlation between the combined inputs and a previously calibrated set of inputs. If the resultant cross-correlation exhibits a sufficient number of peaks (the peaks indicating one or more of the combined inputs match the values of the calibrated inputs), then the behavior engine 5240 may conclude the vehicle 4000 is exhibiting the particular behavior associated with the calibrated inputs.

If the behavior engine 5240 generates a behavior-based command, the command is then sent to a vehicle control unit 5110 in the vehicle control subsystem 5100. The vehicle control unit 5110 may combine the behavior-based command with other inputs, such as explicit commands by the operator 4010 and environmentally generated inputs 5020, to generate a combined set of commands. The vehicle control unit 5110 may also include the stability control unit previously described. Thus, the vehicle control unit 5110 may evaluate whether the combined set of commands can be performed without a loss of vehicle stability.

If the vehicle control unit 5110 determines the combined set of commands would cause the vehicle 4000 to become unstable, the vehicle control unit 5110 may adjust and/or filter the commands to ensure vehicle stability is maintained. This may include reducing the magnitude of the behavior-based command with respect to the other inputs (e.g., by applying a weighting factor). Additionally, precedence may be given to certain inputs based on a predefined set of rules. For example, when the operator 4010 applies pressure to the brake pedal, the vehicle control unit 5110 may ignore the behavior-based command to ensure the vehicle 4000 is able to brake properly. More generally, explicit commands provided by the operator 4010 may be given precedence over the behavior-based command to ensure safety of the vehicle 4000 and the operator 4010. Once the vehicle control unit 5110 validates the combined set of commands, the commands are then applied to the appropriate actuators 5120 of the vehicle to perform the desired behavior.

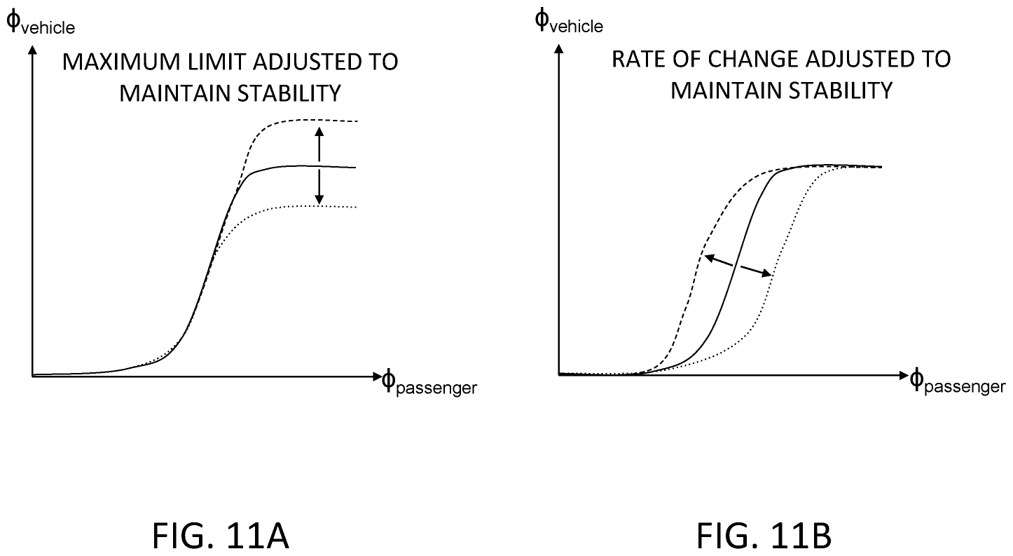

FIGS. 11A and 11B show exemplary calibration maps of a commanded vehicle roll angle, φ_{vehicle}, with respect to the inertial reference frame (e.g., as set by the gravity vector) as a function of the leaning angle of the operator 4010, (φ_{passenger}, with respect to the vehicle reference frame. As shown in FIG. 11A, φ_{vehicle} may remain small at smaller values of (φ_{passenger} to ensure the vehicle 4000 does not roll appreciably in response to small changes to the leaning angle of the operator 4010, thus preventing unintended actuation of the vehicle 4000. As (φ_{passenger} increases, the φ_{vehicle} increases rapidly before saturating. The saturation point may represent a limit imposed by the vehicle control unit 5110 to ensure stability is maintained.

The limits imposed by the vehicle control unit 5110 may vary based on the operating conditions of the vehicle 4000. For example, FIG. 11A shows the upper limit to φ_{vehicle} may be increased or decreased. Changes to the upper limit may be based, in part, the speed of the vehicle 4000 and or the presence of other stabilizing effects (e.g., the gyroscopic stabilizing effect of spinning wheels). FIG. 11B shows the rate φ_{vehicle} changes may also be adjusted to maintain stability. The rate φ_{vehicle} changes as a function of φ_{passenger} may vary based on ride height of the vehicle 4000. If the vehicle 4000 is in a low profile configuration, the vehicle 4000 may have a smaller moment of inertia and is thus able to roll at a faster rate without losing stability.

As shown, the vehicle 4000 may continue to roll up to the saturation limit as the operator 4010 tilts their head. Additionally, the vehicle 4000 may cease responding to the operator 4010 if the operator 4010 returns to their original position within the vehicle 4000. The sensor 4200 may continuously calibrate the operator's default position in the vehicle 4000 in order to provide a continuous update of the original position. In some cases, low-pass filtering with a long time constant may be used to determine a reference position that is treated as the original position of the operator 4010.

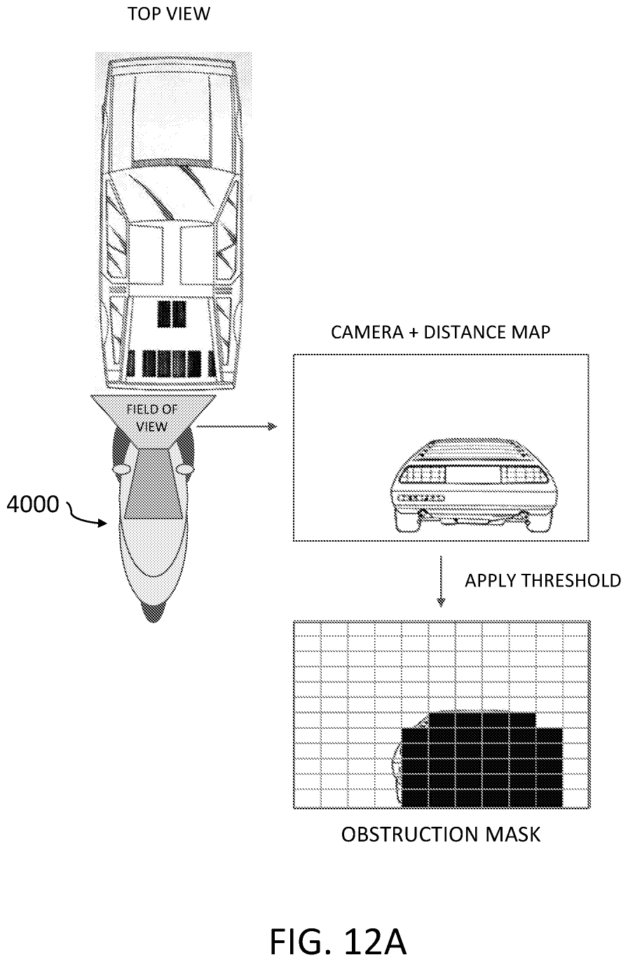

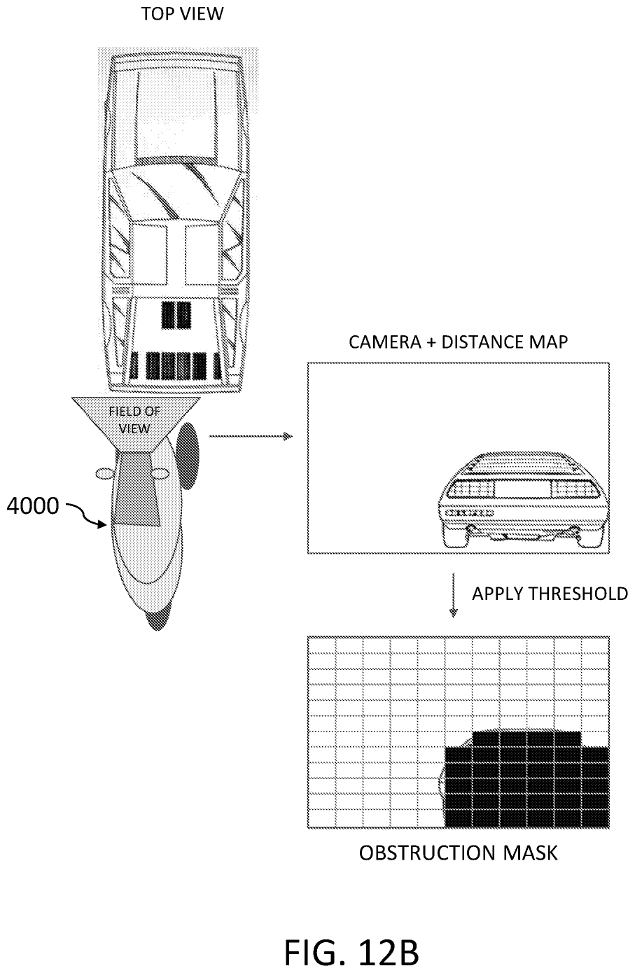

In one exemplary use case, the operator 4010 may tilt their head to look around an obstruction located near the vehicle 4000. Here, the operator-generated input 5010 may include the tilt angle of the operator's head (taken with respect to the vehicle's reference frame) and the environmentally generated input 5020 may be the detection of the obstruction. For example, the environmentally generated input 5020 may be a visibility map constructed by combining 1D or 2D range data (e.g., lidar, ultrasonic, radar data) with a front-facing RGB camera as shown in FIGS. 12A and 12B. The visibility map may indicate the presence of an obstruction (e.g., another vehicle) if the range data indicates the distance between the obstruction and the vehicle 4000 is below a pre-defined threshold (see black boxes in the obstruction mask of FIGS. 12A and 12B). For example, if the obstruction is 10 meters away from the vehicle 4000, the operator 4010 is unlikely leaning to look around the obstruction. However, if the obstruction is less than 2 meters away from the vehicle 4000, the operator 4010 may be deemed to be leaning to look around the obstruction.

### Applications of a Reactive System

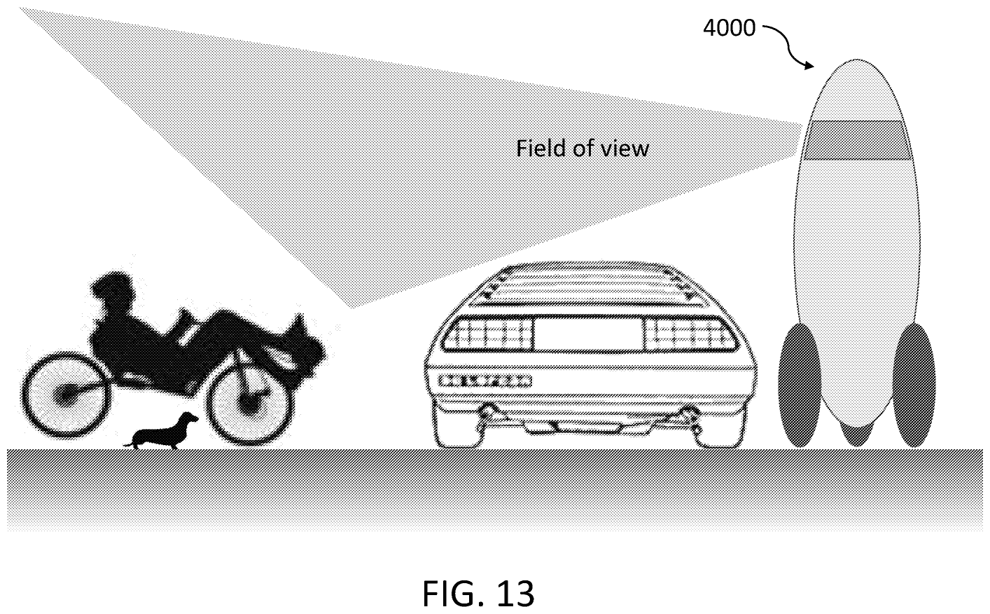

As described above, the sensor 4200 and the reactive system 4300 may enable additional vehicle modalities to improve the performance and/or usability of the vehicle 4000. For instance, the above examples of the video-based mirror 4320 and the articulated joint are primarily directed to modifying the FOV of the operator 4010. As an exemplary use case, FIG. 13 shows a crosswalk that is obscured by a parked vehicle near the vehicle 4000. If the vehicle 4000 includes an articulated joint, the ride height of the vehicle 4000 may be increased to enable the operator 4010 and/or sensors on the vehicle 4000 to detect and detect a cyclist on a recumbent bicycle and a miniature dachshund in the crosswalk.

In another example, the vehicle 4000 may have long travel suspension elements to allow the vehicle 4000 to lean (e.g., +/−45 degrees) in response to the operator 4010 leaning in order to modify vehicle geometry and improve vehicle dynamic performance. For instance, a narrow vehicle is preferable in terms of reducing aerodynamic drag and reducing the urban footprint/increasing maneuverability. However, narrow vehicles may suffer from poor dynamic stability, particularly when cornering due to the narrow track width. When the operator 4010 is cornering at a high rate, it may be beneficial for the vehicle 4000 to lean into the turn like a motorcycle.

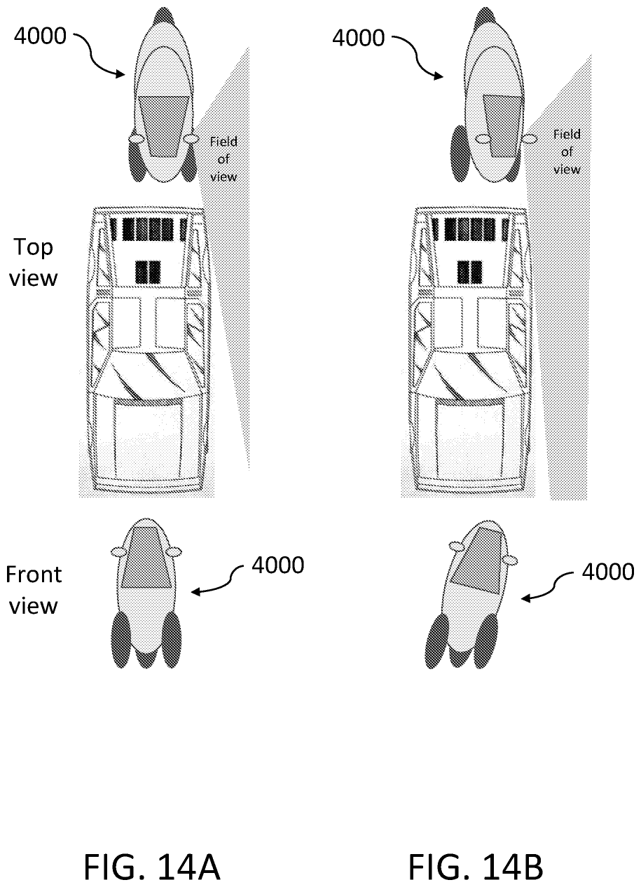

FIGS. 14A and 14B show another exemplary use case where the vehicle 4000 is located behind another vehicle. The operator 4010 may lean their head (or body) to peek around the other vehicle, thus increasing their FOV and their situational awareness. The vehicle 4000 may detect the operator 4010 is leaning within the cabin in order to look around the other vehicle and may respond by tilting the vehicle 4000 to further increase the FOV of the operator 4010. In some cases, the vehicle 4000 may also increase the ride height to further increase the FOV as the vehicle 4000 tilts.

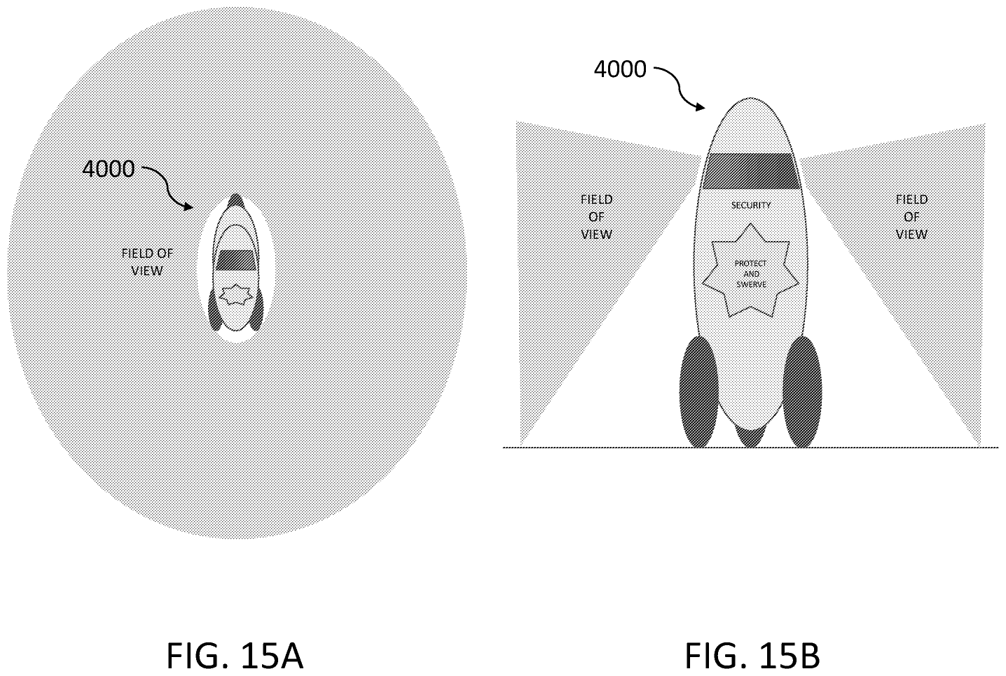

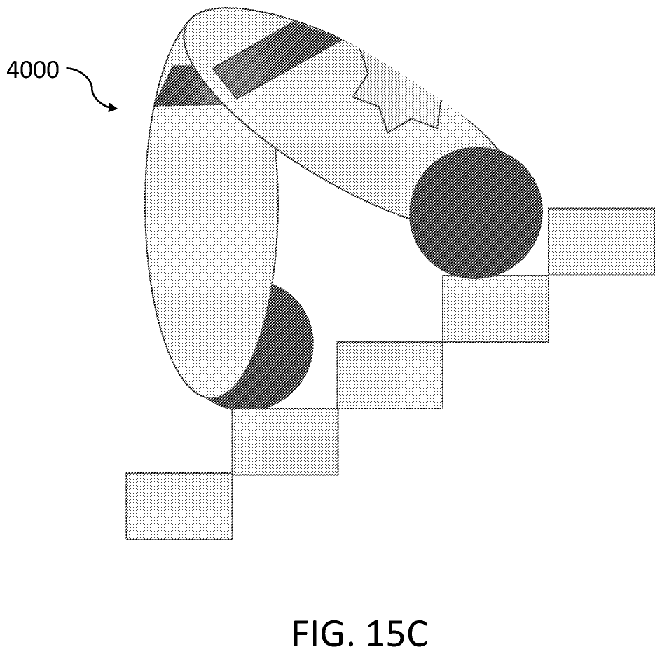

FIGS. 15A-15C show a case where the vehicle 4000 is used an automated security drone. In this case, the reactive system 4300 may respond entirely from environmentally generated inputs. The vehicle 4000 may include a camera that has a 360-degree FOV of the surrounding environment. The reactive system 4300 may be configured to respond in a substantially similar manner to the exemplary vehicles 4000 of FIGS. 14A and 14B, except in this case the reactive system 4300 responds to video imagery acquired by the camera of the environment rather than movement of the operator 4010. For example, the vehicle 4000 may be configured to detect obstructions in the environment and, in response, the reactive system 4300 may actuate an articulated joint to enable the camera to peer around the obstruction and/or to avoid colliding with the obstruction.

The camera may also be configured to detect uneven surfaces. To traverse these surfaces, the vehicle 4000 may be configured to use a walking motion. In some cases, the vehicle 4000 may include additional independent actuation of each wheel to extend static ride height of the vehicle 4000. This walking motion may also be used to enable the vehicle 4000 to traverse a set of stairs (see FIG. 15C) by combining motions from the articulation DOF and/or the long travel suspension DOFs. This capability may enable safe operation of autonomous vehicles while negotiating uncontrolled environments. In cases where the vehicle 4000 has a cabin for an operator 4010, the cabin may be maintained at a desired orientation (e.g., substantially horizontal) to reduce discomfort to the operator 4010 as the vehicle 4000 travels along the uneven surface.

The articulated joint may also provide several dynamic benefits to the operation of the vehicle 4000. For example, vehicle stability may be improved by using the articulated joint to make the vehicle 4000 lean into a turn, which shifts the center of mass in such a way to increase the stability margin, maintain traction, and avoid or, in some instances, eliminate rollover. The articulated joint may also enable greater traction by enabling active control of the roll of the vehicle 4000 through dynamic geometric optimization of the articulated joints. The cornering performance of the vehicle 4000 may also be improved by leaning the vehicle 4000. Additionally, the inverted pendulum principle may be used, particularly at lower vehicle speeds in dense urban environments, by articulating the vehicle 4000 into the high profile configuration and increasing the height of the center of mass (COM). The vehicle 4000 may also prevent motion sickness by anticipating and/or mitigating dynamic motions that generally induce such discomfort in the operator 4010.

The reactive system 4300 may also provide the operator 4010 the ability to personalize their vehicle 4000. For example, the vehicle 4000 may be configured to greet and/or acknowledge the presence of the operator 4010 by actuating an articulated joint such that the vehicle 4000 wiggles and/or starts to move in a manner that indicates the vehicle 4000 is aware of the operator's presence. This may be used to greet the owner of the vehicle 4000 and/or a customer (in the case of a ride hailing or sharing application).

In another example, the vehicle 4000 may also be configured to have a personality. For instance, the vehicle 4000 may be configured to react to the environment 4500 and provide a platform to communicate various goals and/or intentions to other individuals or vehicles on the road. For example, the vehicle 4000 may articulate to a high profile configuration and lean to one side to indicate the vehicle 4000 is yielding the right of way to another vehicle (e.g., at an intersection with a four-way stop sign). In another example, the vehicle 4000 may be traveling along a highway. The vehicle 4000 may be configured to gently wiggle side to side to indicate to other vehicles the vehicle 4000 is letting them merge onto the highway. In another example, the vehicle 4000 may be configured to behave like an animal (e.g., dog-like, tiger-like). In some cases, the type of movements performed by the vehicle 4000 may be reconfigurable. For example, it may be possible to download, customize, trade, evolve, adapt, and/or otherwise modify the personality of the vehicle 4000 to suit the operator's preferences.

In another example, the articulated joint of the vehicle 4000 may also be used to make the vehicle 4000 known to the operator 4010 in, for example, a parking lot. People often forget where they've parked their vehicle in a crowded parking lot. In a sea of sport-utility vehicles (SUVs) and trucks, a very small and lightweight mobility platform may be difficult to find. The articulation and long-travel degrees of freedoms (DOFs) of the vehicle 4000 may enable the vehicle 4000 to become quite visible by articulating the vehicle 4000 to adjust the height of the vehicle 4000 and/or to induce a swaying/twirling motion. In some cases, the vehicle 4000 may also emit a sound (e.g., honking, making sound via the articulated joint) and/or flash the lights of the vehicle 4000.

The vehicle 4000 may also provide other functions besides transportation that can leverage the reactive system 4300 including, but not limited to virtual reality, augmented reality, gaming, movies, music, tours through various locales, sleep/health monitoring, meditation, and exercise. As vehicles become more autonomous, the operator 4010 may have the freedom to use some of these services while traveling from place to place in the vehicle 4000. Generally, the reactive system 4300 may cause the vehicle 4000 to change shape to better suit one of the additional services provided by the vehicle 4000. For example, the vehicle 4000 may be configured to adjust its height while traveling across a bridge to provide the operator 4010 a desirable view of the scenery for a photo-op (e.g., for Instagram influencers).

The vehicle 4000 may also be articulated to reduce glare. For example, the sensor 4200 may detect glare (e.g., from the Sun or the headlights of oncoming traffic) on the operator's ocular region based on the RGB image acquired by the sensor 4200. In response, the vehicle 4000 may adjust its ride height and/or tilt angle to change the position of the operator's ocular region in order to reduce the glare.

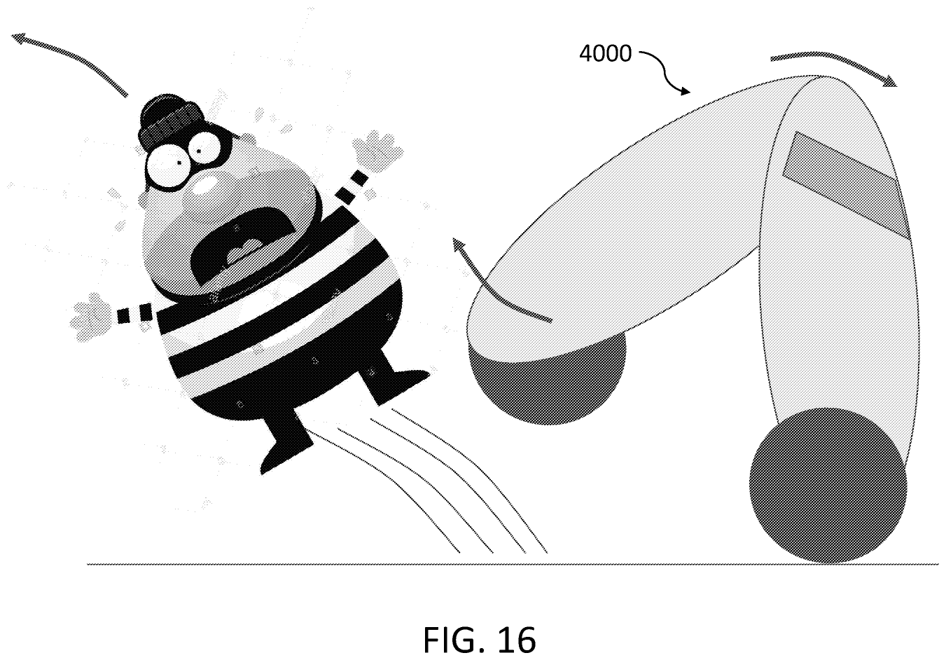

FIG. 16 shows another exemplary vehicle 4000 that includes an articulated joint that is used, in part, as a security system. In general, the vehicle 4000 may be configured to make itself noticed when a person is attempting to steal the vehicle 4000. For example, the vehicle 4000 may emit a sound, flash its lights, or be articulated. If an attempt is made to steal the vehicle 4000, the vehicle 4000 may also use the articulated joint to impede the would-be thief by prevent entry into the vehicle 4000 and/or striking the thief with the body of the vehicle 4000 (e.g., twirling the vehicle 4000 with a bucking motion).

The vehicle 4000 may also include externally facing cameras to enhance situational awareness in order to preemptively ward off potential thieves. The cameras may be used to perform facial recognition on individuals approach the vehicle 4000 (e.g., from behind the vehicle 4000). The computed eigenface of the individual may be cross-referenced with a database of approved operators. If no match is found, the individual may then be cross-referenced with a law enforcement database to determine whether the individual is a criminal.

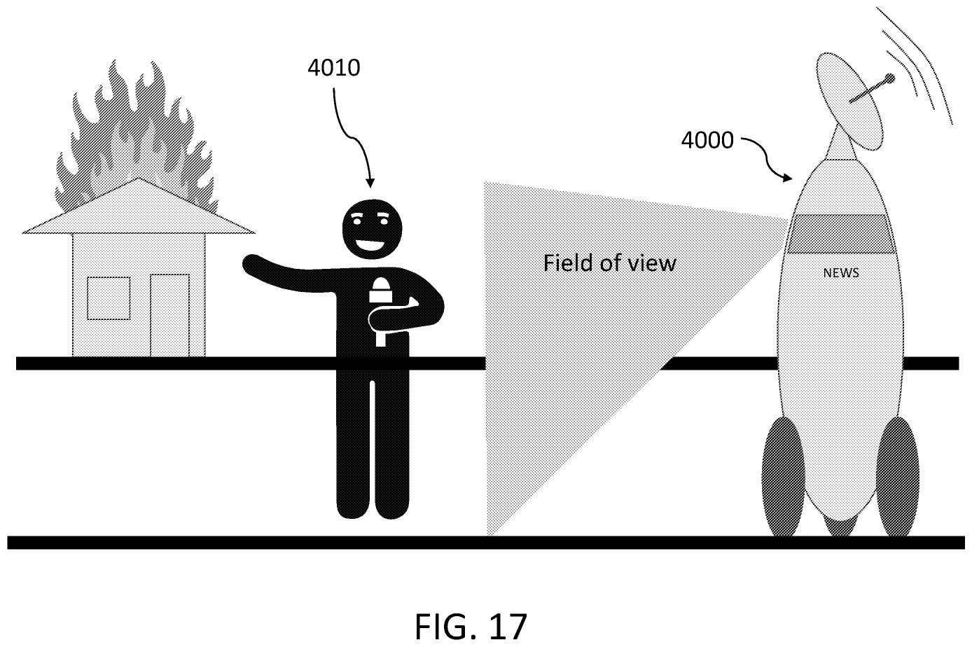

FIG. 17 shows another exemplary application where the vehicle 4000 is used as a tool. The vehicle 4000 may have a relatively compact footprint, range of articulation, and spatial awareness make it a promising tool for tasks beyond transportation. For example, the vehicle 4000 may include an onboard or mounted camera to simultaneously film, light, and smoothly follow a news anchor on location as shown in FIG. 17. Active suspension may be used to keep the shot steady, while articulation may maintain the camera at a preferred height. In another application, the vehicle 4000 may be used to remotely monitor and/or inspect a site (e.g., for spatial mapping) with onboard cameras providing a 360° view of its surroundings.

The position and/or orientation and the camera data of the operator 4010 measured by the sensor 4200 may also be used in other subsystems of the vehicle 4000. For example, the desired listening position (a “sweet spot”) for typical multi-speaker configurations is a small, fixed area dependent on the speaker spacing, frequency response, and other spatial characteristics. Stereo immersion is greatest within the area of the desired listening position and diminishes rapidly as the listener moves out of and away from this area. The vehicle 4000 may include an audio subsystem that utilizes the position data of the operator 4010 and an acoustic model of the cabin of the vehicle 4000 to map the desired listening position onto the operator's head. As the operator 4010 shifts within the cabin, the time delay, phase, and amplitude of each speaker's signal may be independently controlled to shift the desired listening position in order to maintain the desired listening position on the operator's head.

In another example, the depth map and the RGB camera data acquired by the sensor 4200 may be used to identify the operator 4010. For example, the vehicle 4000 may include an identification subsystem that is able to identify the operator 4010 based on a set of pre-trained faces (or bodies). For example, the vehicle 4000 may acquire an image of the operator 4010 when initially calibrating the identification subsystem. The identification subsystem may be used to adjust various vehicle settings according to user profiles including, but not limited to seat settings, music, and destinations. The identification subsystem may also be used for theft prevention by preventing an unauthorized person from being able to access and/or operate the vehicle 4000.

In another example, the depth map and the RGB camera data acquired by the sensor 4200 may also be used to monitor the attentiveness of the operator 4010. For instance, the fatigue of the operator 4010 may be monitored based on the movement and/or position of the operator's eyes and/or head. If the operator 4010 is determined to be fatigued, the vehicle 4000 may provide a message to the operator 4010 to pull over and rest.

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software or a combination thereof. When implemented in software, the software code can be executed on a suitable processor or collection of processors, whether provided in a single computer or distributed among multiple computers.

Further, a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A vehicle, comprising:
a body;
a sensor, coupled to the body, to capture a red, green, blue (RGB) image and a depth map of an environment containing a head of an operator;
a reactive system, coupled to the body, to adjust a field of view (FOV) of the operator when actuated; and
a processor, operably coupled to the sensor and the reactive system, to determine an ocular reference point of the operator based on the RGB image and the depth frame and to actuate the reactive system so as to change the FOV of the operator based on the ocular reference point.

2. The vehicle of claim 1, wherein the depth map is used to mask the RGB image, thus reducing an area of the RGB image for processing.

3. The vehicle of claim 1, wherein the depth map is aligned to the RGB image such that a depth of the environment corresponds to a location of the environment captured in the RGB image.

4. The vehicle of claim 1, wherein:
the reactive system comprises:
a chassis connected component;
an articulated joint, operably coupled to the processor, having a first end coupled to the body and a second end coupled to the chassis connected component,
an actuator, coupled to the articulated joint, to move the second end relative to the first end; and
the processor being configured to activate the actuator so as to move the second end relative to the first end based on the ocular reference point of the user, thereby changing the FOV of the user.

5. The vehicle of claim 4, wherein the articulated joint moves the second end relative to the first end along a first axis of the vehicle in response to the ocular reference point moving along a second axis substantially parallel to the first axis.

6. The vehicle of claim 1, wherein:
the body defines a cabin;
the environment is the cabin;
the reactive system comprises:
a camera, mounted on the body, to capture video imagery of a region outside the vehicle;
a display disposed in the cabin and operably coupled to the processor and the camera;
the processor is configured to modify the video imagery based on the ocular reference point of the operator so as to change the FOV of the operator; and
the display is configured to show the video imagery modified by the processor.

7. The vehicle of claim 6, wherein the processor is configured to modify the video imagery by:
calculating a distance between the ocular reference point and a center point of the display;
scaling a magnitude of the transformation based on a range of motion of the head of the operator; and
adjusting the video imagery based on the distance and the magnitude of the transformation.

8. The vehicle of claim 6, wherein:
the camera is a first camera,
the first video imagery covers a first FOV,
the region outside the vehicle is a first region outside the vehicle,
the reactive system further comprises a second camera, mounted on the body, to capture a second video imagery of a second region outside the vehicle with a second FOV, and
the processor is configured to combine the first video imagery and the second video imagery such that the display transitions seamlessly between the first video imagery and the second video imagery.

9. A reactive mirror system, comprising:
an interior position sensor, disposed in a cabin of the vehicle, to sense a position and/or orientation of a head of a driver of the vehicle;
a camera, mounted on or in the vehicle, to capture a video imagery of a region behind the vehicle;
a processor, operably coupled to the interior position sensor and the camera, to determine an ocular reference point of the driver based on the position and/or orientation of the head of the driver and to modify at least one of a field of view (FOV) or an angle of view of the video imagery based on the ocular reference point; and
a display, in the cabin of the vehicle and operably coupled to the camera and processor, to display at least a portion of the video imagery modified by the processor to the driver.

10. The reactive mirror system of claim 9, wherein the interior position sensor comprises at least one of a pair of infrared (IR) cameras in a stereo configuration to produce a depth map representing at least the head of the driver or a visible light camera to capture a red, green, blue (RGB) image of at least the head of the driver.

11. The reactive mirror system of claim 9, wherein the interior position sensor is configured to sense the position and/or orientation of the head of the driver at a frequency of at least about 60 Hz.

12. The reactive mirror system of claim 9, wherein the camera has a field of view (FOV) in a range between about 10 degrees and about 175 degrees.

13. The reactive mirror system of claim 9, wherein the camera is configured to capture the video imagery at a frame rate of at least about 15 frames per second.

14. The reactive mirror system of claim 9, further comprising:
a control interface, in the vehicle and operably coupled to the camera, the display, and the processor, to adjust at least one of a brightness of the portion of the video imagery, a contrast of the portion of the video imagery, a pan position of the portion of the video imagery, or a FOV of the camera.

15. A method of transforming video imagery displayed to a driver of a vehicle, comprising:
measuring a representation of a cabin of the vehicle, the representation comprising at least one of a depth map or a red, green, blue (RGB) image, the representation showing a head of the driver operating the vehicle;
determining an ocular reference point of the driver based on the representation;
acquiring the video imagery of an area outside the vehicle with a camera mounted on or in the vehicle;
applying a transformation to the video imagery based on the ocular reference point; and
displaying the video imagery to the driver on a display within the cabin of the vehicle.

16. The method of claim 15, wherein the representation comprises the depth map and the RGB image and determining the ocular reference point comprises:
masking the RGB image with the depth map to reduce an area of the RGB image for processing.

17. The method of claim 15, further comprising:
calibrating a default sitting position of the driver.

18. The method of claim 17, further comprising:
calibrating a range of motion of the driver.

19. The method of claim 18, further comprising:
calibrating a positional offset of the display.

20. The method of claim 19, further comprising:
calculating a center point of the display.

21. The method of claim 20, the transformation comprising:
calculating a distance between the ocular reference point and the center point of the display;
scaling a magnitude of the transformation based on the range of motion of the driver; and
adjusting at least one of a field of view of the camera or a pan position of the camera based on the distance and the magnitude of the transformation.

22. The method of claim 20, the transformation comprising:
calculating a target field of view and a target pan position based on a vector from the ocular reference point to the center point of the display;
calculating at least one of a translation or a scale factor based on at least one of a camera focal length, a camera aspect ratio, or a camera sensor size; and
adjusting at least one of a field of view or a pan position of the video imagery based on the at least one of the translation or the scale factor to simulate the target field of view and the target pan position.

23. The method of claim 15, further comprising, before applying the transformation:
applying a correction to the video imagery to reduce at least one of a radial distortion or tangential distortion of the video imagery.

24. A method of adjusting at least one camera mounted on or in a vehicle, comprising:
measuring a representation of a cabin of the vehicle, the representation comprising at least one of a depth map or a red, green, blue (RGB) image, the representation showing a head of a driver operating the vehicle;
determining an ocular reference point of the driver based on the representation;
adjusting at least one of a field of view (FOV) or a pan position of the at least one camera based on the ocular reference point; and
displaying video imagery on at least one display of an area outside the vehicle acquired by the at least one camera.

25. The method of claim 24, wherein the at least one camera includes a first camera to acquire first video imagery and a second camera to acquire second video imagery.

26. The method of claim 25, further comprising:
stitching the first video imagery with the second video imagery so as to provide a seamless FOV between the first camera and the second camera.

27. The method of claim 24, further comprising:
calibrating a default sitting position of the driver;
calibrating a position offset of the video imagery displayed on the at least one display; and
calculating a center point of the video imagery displayed on the at least one display using the default sitting position and the position offset.

28. The method of claim 24, further comprising:
calibrating a range of motion of the driver relative to the default sitting position; and
scaling a panning rate of the at least one camera based on the range of motion of the driver.

29. The method of claim 24, further comprising, before displaying the video imagery:
applying a correction to the video imagery to reduce at least one of a radial distortion or tangential distortion using one or more distortion coefficients.

30. A vehicle, comprising:
a body;
a chassis connected component;
an articulated joint having a first end coupled to the body and a second end coupled to the chassis connected component, the articulated joint comprising:
a guide structure, coupled to the first end and the second end, defining a path, the second end being movable with respect to the first end along the path;
a drive actuator, coupled to the guide structure, to move the second end along the path;
a brake, coupled to the guide structure, to hold the second end to a fixed position along the path in response to being activated;
one or more sensors, coupled to the body, to sense at least one of an operator and an environment surrounding the vehicle; and
a processor, operably coupled to the one or more sensors and the articulated joint, to actuate the articulated joint based on the at least one of the operator or the environment surrounding the vehicle.

31. The vehicle of claim 30, wherein the chassis connected component is a rear body.

32. The vehicle of claim 30, wherein the chassis connected component is a wheel.

33. The vehicle of claim 30, wherein:
the body defines a cabin to contain the operator; and
the one or more sensors are configured to generate a representation of the cabin, the representation showing a head of the operator.

34. The vehicle of claim 33, wherein:
the processor is configured to identify movement of an ocular reference point of the operator based on the representation of the cabin; and
in response to the processor identifying movement of the ocular reference point of the operator along a first axis of the vehicle, the articulated joint is configured to move the body along a second axis substantially parallel to the first axis so as to increase the displacement of the ocular reference point of the operator relative to the environment.

35. The vehicle of claim 34, wherein movement of the body along the axis modifies a field of view (FOV) of the operator.

36. The vehicle of claim 33, wherein the processor is configured to detect glare perceived by the operator based on the representation and to actuate the articulated joint so as to reduce the glare perceived by the operator.

37. The vehicle of claim 33, wherein the representation comprises at least one of a depth map or a red, green, blue (RGB) image.

38. The vehicle of claim 30, wherein the one or more sensors comprises a camera that captures a video imagery of a region of the environment, the video imagery showing a head of an operator.

39. The vehicle of claim 38, wherein:
the processor is configured to determine a relative position of the head of the operator in the video imagery; and
in response to detecting the head of the operator moving relative to the one or more sensors, the processor is configured to actuate the articulated joint to move the body such that the head of the operator returns to the position within the video imagery.

40. The vehicle of claim 30, wherein the body defines a cabin, further comprising:
a camera, mounted on or in the vehicle and operably coupled to the processor, to capture video imagery of a region outside the vehicle; and
a display, disposed in the cabin and operably coupled to the camera and the processor, to display the video imagery to the operator.

41. The vehicle of claim 40, wherein:
the processor is configured to determine an ocular reference point of the operator based on the video imagery and to modify at least one of a first field of view (FOV) or an angle of view of the video imagery based on the ocular reference point of the operator, and
the display is configured to show at least a portion of the video imagery modified by the processor.

42. The vehicle of claim 41, wherein:
in response to the ocular reference point of the operator moving along a first axis of the vehicle, the processor is configured to actuate the articulated joint to move the body along a second axis substantially parallel to the first axis, thereby modifying a FOV of the operator.

43. A method of operating a vehicle, comprising:
receiving a first input from an operator of the vehicle using a first sensor;
receiving a second input from an environment outside the vehicle using a second sensor;
identifying a correlation between the first and second inputs using a processor;
generating a behavior-based command based on the correlation using the processor, the behavior-based command causing the vehicle to move with a pre-defined behavior when applied to an actuator of the vehicle;
generating a combined command based on the behavior-based command, an explicit command from the operator via an input device operably coupled to the processor, and the second input;
at least one of adjusting or filtering the combined command so as to maintain stability of the vehicle; and
actuating the actuator of the vehicle using the adjusted and/or filtered combined command.

44. The method of claim 43, wherein the first input comprises a representation of a cabin of the vehicle, the representation showing a head of the operator.

45. The method of claim 44, wherein the pre-defined behavior comprises moving the vehicle along a first axis in response to the processor identifying movement of the head of the operator moving along a second axis substantially parallel to the first axis based on the representation.

46. The method of claim 44, wherein the processor is configured to detect glare perceived by the operator based on the representation and the pre-defined behavior comprises moving the vehicle so as to reduce the glare perceived by the operator.

47. The method of claim 43, wherein the second input comprises at least one of a traction of a wheel in the vehicle, a temperature of the environment, or an image of the environment showing at least one of another vehicle or a person.

48. The method of claim 43, wherein the input device is at least one of a steering wheel, an accelerator, or a brake.

49. The method of claim 43, wherein the explicit command takes precedence over the behavior-based command.
